(19) United States
(12) Patent Application Publication
(10) Pub. No.: US 2025/0056559 A1
(43) Pub. Date: Feb. 13, 2025

(54) DYNAMIC SWITCHING OF SPATIAL FILTER FOR MULTI-TRP SYSTEMS

(71) Applicant: Telefonaktiebolaget LM Ericsson (publ), Stockholm (SE)

(72) Inventors: Andreas NILSSON, Göteborg (SE); Siva MURUGANATHAN, Stittsville (CA); Shiwei GAO, Nepean (CA)

(21) Appl. No.: 18/687,101

(22) PCT Filed: Aug. 30, 2022
(86) PCT No.: PCT/IB2022/058129

§ 371 Date: Feb. 27, 2024

Related U.S. Application Data
(60) Provisional application No. 63/238,609, filed on Aug. 30, 2021.

(51) Int. Cl. H04W 72/232; H04L 5/00

(52) U.S. Cl. CPC H04W 72/232; H04L 5/0053

(57) ABSTRACT

A network node configured to communicate with a wireless device (WD) is described. An indication indicating to the WD to perform one of a single-TRP operation and a multi-TRP operation for one or more physical channels is determined. The determined indication includes at least one of a first dedicated bit field in a downlink related downlink control information (DCI) scheduling a downlink physical channel; a second dedicated bit field in an uplink related DCI scheduling an uplink physical channel; a first transmission configuration indicator (TCI) bit field in the downlink related DCI, at least one codepoint of the first TCI bit field indicating a single third unified TCI state; a second TCI bit field in the uplink related DCI, at least one other codepoint of the second TCI bit field indicating a single fourth unified TCI state. The determined indication is transmitted to the WD.

### TECHNICAL FIELD

The present disclosure relates to wireless communications, and in particular, to dynamic switching of spatial filter(s) for multiple transmission/reception point (multi-TRP) systems.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD) such as user equipment (UE), as well as communication between network nodes and between WDs.

In NR, several signals can be transmitted from different antenna ports of a same base station. These signals can have the same large-scale properties such as Doppler shift/spread, average delay spread, or average delay. These antenna ports then may be said to be quasi co-located (QCL).

If a WD knows that two antenna ports are QCL with respect to a certain parameter (e.g. Doppler spread), the WD can estimate that parameter based on one of the antenna ports and apply that estimate for receiving signal on the other antenna port. For example, there may be a QCL relation between a CSI-RS for tracking reference signal (TRS) and the physical downlink shared channel (PDSCH) demodulation reference signal (DMRS). When a WD receives the PDSCH DMRS, the WD can use the measurements already made on the TRS to assist the DMRS reception.

Information about what assumptions can be made regarding QCL may be signaled to the WD from the network node. In NR, four types of QCL relations between a source RS and a target RS may be defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no definition of spatial QCL, but an interpretation may be that if two transmitted antenna ports are spatially QCL, the WD can use the same reception/receiver (Rx) beam to receive them. This may be helpful for a WD that uses analog beamforming to receive signals, since the WD adjusts its RX beam in some direction prior to receiving a certain signal. If the WD knows that the signal is spatially QCL with some other signal it has received earlier, then the WD can use the same RX beam to receive also this signal. Note that for beam management, although QCL Type D may be useful, conveying other QCL types such as Type A QCL for the RSs to the WD can also be useful for the WD to estimate all the relevant large-scale parameters.

Typically, this is achieved by configuring the WD with a CSI-RS for tracking (TRS) for time/frequency offset estimation. To be able to use any QCL reference signal, the WD may have to receive it with a sufficiently good signal-to-interference-plus-noise ratio (SINR). In many cases, this means that the TRS may have to be transmitted in a suitable beam to a WD.

To support dynamic beam and/or transmission and reception point (TRP) selection, a WD can be configured through radio resource control (RRC) signaling with up to 128 TCI (Transmission Configuration Indicator) states. The TCI state information element is shown below.

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI state may include QCL information related to one or two RSs. For example, a TCI state may include CSI-RS1 associated with QCL Type A and CSI-RS2 associated with QCL Type D. If a third RS, e.g., the physical downlink control channel (PDCCH) DMRS, is configured or activated with this TCI state for a WD, the WD may derive Doppler shift, Doppler spread, average delay, delay spread from CSI-RS1 and Spatial Rx parameter (i.e., the RX beam to use) from CSI-RS2 when performing channel estimation for the PDCCH based on the DMRS.

Further, a first list of available TCI states may be configured for PDSCH, and a second list of TCI states may be configured for PDCCH. Each TCI state may include a pointer, i.e., TCI State identifier (ID), which points to the TCI state. The network node may activate via MAC CE one TCI state for PDCCH (i.e., provides a TCI state for PDCCH) and up to eight TCI states for PDSCH. The number of active TCI states supported by a WD is a WD capability, but the typical maximum is 8.

Assuming a WD has 4 activated TCI states (from a list of totally 64 configured TCI states), 60 TCI states may be inactive for this particular WD. The WD need not be prepared to have large scale parameters estimated for those inactive TCI states. However, the WD may continuously track and update large scale parameters for the RSs in the 4 active TCI states. When scheduling a PDSCH to a WD, the DCI may include a pointer to one or two of the activated TCI states. The WD then knows which large-scale parameter to estimate and use when performing PDSCH DMRS channel estimation and thus PDSCH demodulation.

In some cases, it may be sufficient to use downlink control information (DCI) signaling, e.g., as long as the WD can use any of the currently activated TCI states. However, at some point in time, none of the source reference signals (RSs) in the currently activated TCI states may be received by the WD, i.e., when the WD moves out of the beams in which the source RSs in the activated TCI states are transmitted. When this happens (or actually before this happens), the network node (e.g., gNB) may have to activate new TCI states. Typically, since the number of activated TCI states is fixed, the network node (e.g., gNB) would also have to deactivate one or more of the currently activated TCI states.

The two-step procedure related to TCI state update in NR Release 15 is shown in FIG. 1. FIG. 1 illustrates an example of two-stage TCI state update. A TCI state is selected from the activated set of TCI states using DCI, and the set of activated TCI states is updated using medium access control (MAC) control element (CE).

### TCI States Activation/Deactivation for WD-Specific PDSCH Via MAC CE

MAC CE signaling may be used to activate/deactivate TCI states for WD specific PDSCH. An example structure of the MAC CE for activating/deactivating TCI states for WD specific PDSCH is given in FIG. 2.

As shown in FIG. 2, the MAC CE may include the following fields:
Serving Cell ID: This field indicates the identity of the Serving Cell for which the MAC CE applies. The length of the field may be 5 bits;
BWP ID: This field may include the ID corresponding to a downlink bandwidth part for which the MAC CE applies. The BWP ID may be given by the higher layer parameter BWP-Id, e.g., as specified in 3GPP TS 38.331. The length of the BWP ID field may be 2 bits since a WD can be configured with up to 4 BWPs for DL;
A variable number of fields Tᵢ: If the WD is configured with a TCI state with TCI State ID i, then the field Tᵢ may indicate the activation/deactivation status of the TCI state with TCI State ID i. If the WD is not configured with a TCI state with TCI State ID i, the MAC entity may ignore the Tᵢ field. The Tᵢ field is set to “1” to indicate that the TCI state with TCI State ID i may be activated and mapped to a codepoint of the DCI Transmission Configuration Indication field, e.g., as specified in 3GPP TS 38.214/38.321. The Tᵢ field may be set to “0” to indicate that the TCI state with TCI State ID i is to be deactivated and is not mapped to any codepoint of the DCI Transmission Configuration Indication field. It should be noted that the codepoint to which the TCI State is mapped may be determined by the ordinal position among all the TCI States with Tᵢ field set to “1”. That is, the first TCI State with Tᵢ field set to “1” shall be mapped to the codepoint value 0 of DCI Transmission Configuration Indication field, the second TCI State with Tᵢ field set to “1” may be mapped to the codepoint value 1 of DCI Transmission Configuration Indication field, and so on. In NR Release-15, the maximum number of activated TCI states is 8;
A Reserved bit R: this bit is set to ‘0’ in NR Release-15.

Note that the TCI States Activation/Deactivation for WD-specific PDSCH MAC CE is identified by a MAC protocol data unit (PDU) subheader with logical channel ID (LCID) as specified in Table 6.2.1-1 of 3GPP Technical Specification (TS) 38.321 (see FIG. 2). The MAC CE for Activation/Deactivation of TCI States for WD-specific PDSCH has variable size.

FIG. 2 shows TCI States Activation/Deactivation for WD-specific PDSCH MAC CE (e.g., as in FIG. 6.1.3.14-1 of 3GPP TS 38.321).

### TCI State Indication for WD-Specific PDSCH Via DCI

The network node (e.g., gNB) can use DCI format 1_1 or 1_2 to indicate to the WD that it may use one of the activated TCI states for the PDSCH reception. The field used in the DCI may be a TCI field (which may be 3 bits if tci-PresentInDCI is “enabled” or tci-PresentForDCI-Format1-2-r16 is present respectively for DCI format 1_1 and DCI 1_2 by higher layer). One example of such a TCI state indication is shown in FIG. 3. More specifically, FIG. 3 shows an example of indication of a TCI state by a TCI codepoint of a TCI field in DCI, where eight TCI states, i.e., TCI states {3, 7, 9, 12, 25, 36, 42, 57}, are activated. The TCI field gives a pointer into the ordered list of activated TCI states. TCI code point 0 indicates the first TCI state index in the list of TCI states, i.e., TCI state 3 in the example, TCI code point 1 indicates the second TCI state index in the list, i.e., TCI state 7 in the example, and so on.

### Multi-TRP TCI State Operation

In 3GPP Release 16, a multi-TRP (multiple-transmission reception point) operation was specified. Multi-TRP may include two modes of operation, single DCI based multi-TRP, and multiple DCI based multi-TRP.

In 3GPP NR Release 16, multiple DCI scheduling may be used for multi-TRP operations in which a WD may receive two DCIs, each scheduling a PDSCH/PUSCH. The two DCIs (carried by respective PDCCHs which scheduled respective PDSCH) may transmitted from the same network node (e.g., TRP).

For multi-DCI multi-TRP operation, a WD is to be configured with two control resource set (CORESET) pools, each associated with a TRP. Each CORESET pool May be a collection of CORESETs that belongs to the same CORESET pool. A CORESET pool index may be configured in each CORESET with a value of 0 or 1. For the two DCIs in the above example, they may be transmitted via respective PDCCHs in two CORESETs belonging to different CORESET pools (i.e., with CORESETPoolIndex 0 and 1 respectively). For each CORESET Pool, the same TCI state operation method in terms of activation/deactivation/indication as for described herein may be assumed.

For single DCI based multi-TRP operation, two DL TCI states may be associated to one TCI codepoint. That is, when a TCI field codepoint in DCI indicates two TCI states, each TCI state corresponds to a different beam or different TRP. The activation and mapping of 2 TCI states for a codepoint in the TCI field of DCI may be performed with the below MAC CE (e.g., from 3GPP TS 38.321):

### Enhanced TCI States Activation/Deactivation for WD-Specific PDSCH MAC CE

The Enhanced TCI States Activation/Deactivation for WD-specific PDSCH MAC CE may be identified by a MAC PDU subheader with eLCID as specified in Table 6.2.1-1b. It has a variable size consisting of following fields:
Serving Cell identifier (ID): This field indicates the identity of the Serving Cell for which the MAC CE applies. The length of the field is 5 bits;
Bandwidth part (BWP) ID: This field indicates a DL BWP for which the MAC CE applies as the codepoint of the DCI bandwidth part indicator field as specified in 3GPP TS 38.212. The length of the BWP ID field is 2 bits;
Cᵢ: This field indicates whether the octet containing TCI state ID_{i,2} is present. If this field is set to “1”, the octet containing TCI state ID_{i,2} is present. If this field is set to “0”, the octet containing TCI state ID_{i,2} is not present;
TCI state ID_{i,j}: This field indicates the TCI state identified by TCI-StateId as specified in 3GPP TS 38.331, where i is the index of the codepoint of the DCI Transmission configuration indication field as specified in TS 38.212 and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e., the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2.
R: Reserved bit, set to “0”.

See FIG. 4 for an example of an Enhanced TCI States Activation/Deactivation for WD-specific PDSCH MAC CE.

### Inter-Cell Multi-TRP Operation

In NR Release-17, inter-cell multi-TRP operation is to be specified. This is an extension of either single DCI based multi-TRP, or multiple DCI based multi-TRP operation of 3GPP Release-16. The intercell aspect of Release-17 refers to the case when the two TRPs are associated to different SSBs each associated with a different PCI (Physical Cell ID). That is, a TCI state associated with a transmission from TRP 1 or TRP 2 is quasi-collocated to either one of the SSBs with the PCI belonging to that TRP, or another reference signal such as a channel state information reference signal (CSI-RS) that is QCLed to one of the SSBs with physical cell identifier (PCI) belonging to that TRP.

### 3GPP Release-17 TCI State Framework

In 3GPP Release-17 a unified TCI state framework is being considered, which aims to streamline the indication of transmit/receive spatial filter (and other QCL properties) to the WD such as by using a single TCI state to indicate QCL properties for multiple different downlink (DL) and/or uplink (UL) signals/channels. Thus, a TCI state can be for DL only (i.e., DL TCI state), UL only (i.e., UL TCI state), or for both DL and UL (i.e., joint DL/UL TCI state). Which DL/UL signals/channels that the unified TCI state framework should be applied to are being debated in 3GPP, e.g.:

### Considerations:

Whether downlink (DL) or, if applicable, joint TCI also applies to the following signals. If not, for further study (FFS) any other enhancement over 3GPP Releases 15/16:
   CSI-RS resources for CSI
   Some CSI-RS resources for BM, if so, which ones (e.g., aperiodic, repetition ‘ON’)
   CSI-RS for tracking
Whether uplink (UL) or, if applicable, joint TCI also applies to the following signals
   Some SRS resources or resource sets for BM

Note that the term ‘joint TCI’ described above may refer to a ‘joint DL/UL TCI state’.

The unified TCI state framework may include a three stage TCI state indication for all or a subset of all DL and/or UL channels/signals. In the first stage, RRC may be used to configure a list of TCI states. In the second stage, one or more of the RRC configured TCI states may be activated via MAC-CE signaling and associated to different TCI field codepoints in DCI format 1_1 and 1_2. Finally, in the third stage, DCI signaling may be used to select one of the activated TCI states (or two TCI states in case separate TCI states are used for DL channels/signals and UL channels/signals).

Further, supporting both joint beam indication (“Joint DL/UL TCI”) and separate DL/UL beam indication (“Separate DL/UL TCI”) has been considered, as described below. For Joint DL/UL TCI, a single TCI state (which for example can be a Joint DL/UL TCI state) may be used to determine a transmit/receive spatial filter for both DL signals/channels and UL signals/channels. For Separate DL/UL TCI, one TCI state (for example a DL TCI state) may be used to indicate a receive spatial filter for DL signals/channels, and a separate TCI state (for example an UL TCI state) may be used to indicate a transmit spatial filter for UL signals/channels.

### Consideration:

With respect to beam indication signaling medium to support joint or separate DL/UL beam indication, e.g., in 3GPP Rel.17 unified TCI framework:
Support L1-based beam indication using at least WD-specific (unicast) DCI to indicate joint or separate DL/UL beam indication from the active TCI states.
   The existing DCI formats 1_1 and 1_2 are reused for beam indication
Support activation of one or more TCI states via MAC CE analogous to 3GPP Releases 15/16:

### Consideration:

With respect to 3GPP Release-17 unified TCI framework, to accommodate the case of separate beam indication for UL and DL:
Utilize two separate TCI states, one for DL and one for UL.
For the separate DL TCI:
   The source reference signal(s) in M TCIs provide QCL information at least for WD-dedicated reception on PDSCH and for WD-dedicated reception on all or subset of CORESETs in a component carrier (CC).
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC.
   Optionally, this UL TX spatial filter can also apply to all sounding reference signal (SRS) resources in resource set(s) configured for antenna switching/codebook-based/non-codebook-based UL transmissions.
For further study (FFS): Whether the UL TCI state is taken from a common/same or separate TCI state pool from DL TCI state

### Ultra-Reliable Low Latency Communication (URLLC) Reliability for Multi-TRP Operation.

In NR Release-16, multi-TRP reliability enhancements have been specified for PDSCH by receiving PDSCH (using time division multiplexing/frequency division multiplexing (TDM/FDM) or spatial division multiplexing (SDM)) from two different TRPs.

In NR Release-16, a PDSCH may be transmitted to a WD from multiple TRPs. Since different TRPs may be located in different physical locations and/or have different beams, the propagation channels can be different. To facilitate receiving PDSCH data from different TRPs or beams, a WD may be indicated with two TCI states, each associated with a TRP or a beam, by a single codepoint of a TCI field in a DCI.

One example of PDSCH transmission over two TRPs using a single DCI is shown in FIG. 5, where different layers of a PDSCH with a single codeword (e.g., CW0) are sent over two TRPs, each associated with a different TCI state. In this case, two DMRS ports, one for each layer, in two code division multiplexing (CDM) groups may also be signaled to the WD. A first TCI state may be associated with the DMRS port in a first CDM group, and a second TCI state may be associated with the DMRS port in a second CDM group. This approach is often referred to as NC-JT (Non-coherent joint transmission) or SDM (spatial division multiplexing).

Transmitting PDSCH over multiple TRPs can also be used to improve PDSCH transmission reliability for URLLC applications. A number of approaches are introduced in NR Release-16 including “FDMSchemeA”, “FDMSchemeB”, “TDMSchemeA” and Slot based TDM scheme.

An example of multi-TRP PDSCH transmission with FDMSchemeA is shown in FIG. 6, where a PDSCH is sent over TRP1 in PRGs (precoding RB group) {0, 2, 4} and over TRP2 in PRGs {1,3,5}. The transmission from TRP1 may be associated with TCI state 1, while the transmission from TRP2 may be associated with TCI state 2. Since the transmissions from TRP1 and TRP2 are non-overlapping in the case of FDMSchemeA, the DMRS ports can be the same (i.e., DMRS port 0 used for both transmissions). The PDSCH may be scheduled by a PDCCH which may be sent over TRP1. The FDMSchemeA multi-TRP PDSCH scheme belongs to the category of FDM DL reception schemes.

FIG. 7 shows an example data transmission with FDMSchemeB in which PDSCH #1 is transmitted in PRGs {0, 2, 4} from TRP1 and PDSCH #2 with the same TB is transmitted in PRGs {1,3,5} from TRP2. The transmission from TRP1 may be associated with TCI state 1, while the transmission from TRP2 may be associated with TCI state 2. Since the transmissions from TRP1 and TRP2 are non-overlapping in the case of FDMSchemeB, the DMRS ports may be the same (i.e., DMRS port 0 used for both transmissions). The two PDSCHs may carry the same encoded data payload but with a same or different redundancy version so that the WD can do soft combining of the two PDSCHs to achieve more reliable reception. The FDMSchemeB multi-TRP PDSCH scheme belongs to the category of FDM DL reception schemes.

FIG. 8 shows an example data transmission with TDMSchemeA in which PDSCH repetition occurs in mini-slots of 4 OFDM symbols within a slot. Each PDSCH can be associated with a same or different redundancy version (RV). The transmission of PDSCH #1 from TRP1 may be associated with a first TCI state, while the transmission of PDSCH #2 from TRP2 may be associated with a second TCI state. The TDMSchemeA multi-TRP PDSCH scheme belongs to the category of TDM DL reception schemes.

An example Multi-TRP data transmission with Slot based TDM scheme is shown in FIG. 9, where 4 PDSCHs for a same transport block (TB) are transmitted over 2 TRPs and in 4 consecutive slots. Each PDSCH may be associated with a different RV. The transmission of odd numbered PDSCHs from TRP1 may be associated with a first TCI state, while the transmission of even numbered PDSCHs from TRP2 may be associated with a second TCI state. The Slot based TDM multi-TRP PDSCH scheme belongs to the category of TDM DL reception schemes.

For all the single-PDCCH based DL multi-TRP PDSCH schemes, a single DCI transmitted from one TRP may be used to schedule multiple PDSCH transmissions over two TRPs. The network configures the WD with multiple TCI states via RRC, and a new MAC CE was introduced in NR Release-16. This MAC CE can be used to map a codepoint in the TCI field to one or two TCI states.

Further, in NR Release-17, URLLC reliability enhancements is being extended also for PUSCH and PUCCH by using TDM repetition from two different TRPs. In NR Rel-17, it has been agreed that PUSCH repetition to two TRPs in a cell will be supported. For that purpose, two SRS resource sets with usage set to either ‘codebook’ or ‘nonCodebook’ may be introduced, where each SRS resource set may be associated with a TRP. PUSCH repetition to two TRPs can be scheduled by an UL related DCI with two SRS resource indicator (SRI) fields, where a first SRI may be associated with a first SRS resource set and a second SRI may be associated with a second SRS resource set.

An example is shown in FIG. 10, where a PUSCH repetition towards two TRPs is scheduled by a DCI indicating two SRIs. Both type A and type B PUSCH repetitions may be supported.

Two types of mappings may be supported between PUSCH transmission occasions to TRPs or UL beams, i.e.,
Cyclical mapping pattern: the first and second UL beams may be applied to the first and second PUSCH repetitions, respectively, and the same beam mapping pattern may continue to the remaining PUSCH repetitions.
Sequential mapping pattern: the first beam is applied to the first and second PUSCH repetitions, and the second beam may be applied to the third and fourth PUSCH repetitions. The same beam mapping pattern may continue to the remaining PUSCH repetitions.

The first and second UL beams may be used to transmit PUSCH towards the first and second TRPs, respectively.

### Existing Dynamic Switching Schemes

In order to quickly switch between single-TRP operation (which typically is useful for enhanced mobile broadband (eMBB) applications) and multi-TRP operation (which typically is useful for URLLC applications), it was agreed to support dynamic switching between these two modes of operation for PUSCH in NR Release-17. Note that dynamic switching between single-TRP operation and multi-TRP operation for PDSCH may also be supported in NR from Release-16.

Note that in NR Release-17, dynamic switching between single-TRP transmission and multi-TRP transmission for PUSCH is supported in the following way. A new field is introduced in UL related DCI to indicate whether the PUSCH transmission corresponds to a single-TRP transmission or a multi-TRP transmission. If a single-TRP operation is indicated by the newly introduced field in UL related DCI, then:
the SRI (SRS resource indicator) for codebook based PUSCH transmission may indicate an SRS resource from one SRS resource set among two SRS resource sets configured for codebook based PUSCH; the SRI for codebook based PUSCH transmission may be indicated by one SRI field in UL related DCI;
the SRI(s) for non-codebook based PUSCH transmission indicate SRS resources from one SRS resource set among two SRS resource sets configured for non-codebook based PUSCH; the SRI(s) for non-codebook based PUSCH transmission may be indicated by one SRI field in UL related DCI;
the TPMI for codebook based PUSCH transmission may be indicated by one TPMI field in UL related DCI;

If a multi-TRP operation is indicated by the newly introduced field in UL related DCI, then:
the SRIs for codebook based PUSCH transmission indicate SRS resources from two different SRS resource sets which are configured for codebook based PUSCH; the SRIs for codebook based PUSCH transmission may be indicated by two different SRI fields in UL related DCI; here, the two different SRS resource sets/SRI fields may represent PUSCH transmission towards two TRPs;
the SRIs for non-codebook based PUSCH transmission indicate SRS resources from two different SRS resource sets which may be configured for non-codebook based PUSCH; the SRIs for non-codebook based PUSCH transmission may be indicated by two different SRI fields in UL related DCI; here, the two different SRS resource sets/SRI fields may represent PUSCH transmission towards two TRPs;
the TPMIs for codebook based PUSCH transmission are indicated by two different TPMI fields in UL related DCI; here, the two different TPMI fields may represent PUSCH transmission towards two TRPs

In NR, dynamic switching between single-TRP operation and multi-TRP operation for PDSCH is supported in a different way as compared to the way dynamic switching is done for PUSCH. For PDSCH, dynamic switching between single-TRP operation and multi-TRP operation are indicated by the number of TCI states indicated by the codepoint of the TCI field in DL related DCI. If the codepoint of the TCI field in DL related DCI indicates a single TCI state, then the PDSCH transmission may correspond to a single-TRP operation (note that the TCI field here represents PDSCH reception from the single TRP). If the codepoint of the TCI field in DL related DCI indicates two TCI states, then the PDSCH transmission may correspond to multi-TRP (i.e., 2 TRP) operation (note that the two TCI fields here represent PDSCH reception from the two TRPs).

In sum, in the current 3GPP discussions about unified TCI framework, the focus has been on TCI state updates for single TRP. How to support multi-TRP operation for the unified TCI state framework and how to dynamically switch between single-TRP and multi-TRP operations in the unified TCI framework are open problems to be solved. Further, typical procedures in NR for dynamic switching between single-TRP and multi-TRP operation are separate for uplink and downlink. Typical procedures are also used for dynamic switching in NR are not suitable for the unified TCI framework.

### SUMMARY

Some embodiments advantageously provide methods, systems, and apparatuses for dynamic switching of spatial filter for multi-TRP systems.

In one embodiment, a network node is configured to transmit a configuration comprising a list of TCI states; activate a subset of the list of TCI states via MAC CE signaling to the WD one or more of the TCI states that may be mapped to a single codepoint update a number, N, of the TCI states via DCI signaling to the WD; and/or communicate with the WD using at least one of the TCI states based on the number N.

In one embodiment, a WD is configured to receive a configuration comprising a list of TCI states; receive an activation of a subset of the list of TCI states via MAC CE signaling, where one or more of the TCI states may be mapped to a single codepoint; receive DCI signaling updating a number, N, of the TCI states; and communicate with the network node using at least one of the TCI states based on the number N.

According to one aspect, a network node configured to communicate with a wireless device (WD) is described. The WD has been activated and indicated with first and second unified transmission configuration indicator (TCI) states for at least one of downlink (DL) reception from and uplink (UL) transmission to first and second transmission and reception points (TRPs), respectively, by the WD. The WD (and/or the network node) is able to perform a single-TRP operation including at least one of transmitting to and receiving from one of the first and second TRPs. The WD (and/or the network node) is able to perform a multi-TRP operation including at least one of transmitting to and receiving from both the first and the second TRPs. Each of the first and the second unified TCI states comprise either a DL TCI state and a UL TCI state, or a joint UL and DL TCI state.

The network node comprises processing circuitry configured to determine an indication indicating to the WD to perform one of the single-TRP operation and the multi-TRP operation for one or more physical channels, the determined indication including at least one of: a first dedicated bit field in a downlink related downlink control information (DCI) scheduling a downlink physical channel; a second dedicated bit field in an uplink related DCI scheduling an uplink physical channel; a first TCI bit field in the downlink related DCI, at least one codepoint of the first TCI bit field indicating a single third unified TCI state; and a second TCI bit field in the uplink related DCI, where at least one other codepoint of the second TCI bit field indicates a single fourth unified TCI state. The network node also comprises a radio interface in communication with the processing circuitry. The radio interface is configured to transmit the determined indication to the WD.

In some embodiments, the first dedicated bit field indicates at least one of: the downlink physical channel is transmitted according to the first unified TCI state and is expected to be received according to the first unified TCI state; the downlink physical channel is transmitted according to the second unified TCI state and is expected to be received according to the second unified TCI state; the downlink physical channel is transmitted according to both the first and second unified TCI states and is expected to be received according to both the first and the second unified TCI states; the downlink physical channel is transmitted according to both the first and second unified TCI states starting from the first unified TCI state; and the downlink physical channel is transmitted according to both the first and second unified TCI states starting from the second unified TCI state.

In some other embodiments, the second dedicated bit field indicates at least one of the uplink physical channel is transmitted according to the first unified TCI state; the uplink physical channel is transmitted according to the second unified TCI state; the uplink physical channel is transmitted according to both the first and second unified TCI states; the uplink physical channel is transmitted according to both the first and second unified TCI states starting from the first unified TCI state; and the uplink physical channel is transmitted according to both the first and second unified TCI states starting from the second unified TCI state.

In one embodiment, the third unified TCI state is equal to one of the first and the second unified TCI states.

In another embodiment, the single TRP operation is performed by the WD only for one downlink physical channel scheduled by the same DCI when the single third unified TCI state is indicated by the first TCI bit field.

In some embodiments, the single fourth unified TCI state is one of the first and the second unified TCI states.

In some other embodiments, the single third unified TCI state is not equal to either the first or the second unified TCI state.

In an embodiment, the downlink TCI state comprises information about a first spatial filter to be used for downlink reception.

In another embodiment, the UL TCI state comprises information about a second spatial filter to be used for uplink transmission.

In some embodiments, the joint UL and DL TCI state comprises information about a third spatial filter common to both downlink reception and uplink transmission.

In some other embodiments, the transmitting or the receiving according to a unified TCI state implies transmitting or receiving with a fourth spatial filter associated to the unified TCI state.

In an embodiment, the at least one of the first, the second, the third, and the fourth spatial filters is defined by a reference signal associated to a quasi-colocation type D.

In another embodiment, the first and the second unified TCI states correspond to a first common beam associated with the first TRP and a second common beam associated with the second TRP, respectively.

In some embodiments, the downlink related DCI is one of a DCI format 1_1 and a DCI format 1_2.

In some other embodiments, the uplink related DCI is one of another DCI format 0_1 and another DCI format 0_2.

In an embodiment, the first dedicated bit field is different than the first TCI bit field.

In another embodiment, the single TRP operation is performed by the WD when a single unified TCI state is indicated by the first TCI bit field.

In some embodiments, the single TRP operation is performed by the WD only for one uplink physical channel scheduled by the DCI.

In some other embodiments, the multi-TRP operation is performed by the WD when two unified TCI states are indicated by the first TCI bit field.

In an embodiment, the multi-TRP operation is applied to all of the one or more physical channels.

In another embodiment, the downlink physical channel is a downlink physical shared channel, PDSCH, and the uplink physical channel is an uplink physical shared channel, PUSCH.

In some embodiments, the one or more physical channels is one or more of one PDSCH, one PUSCH, and one PUCCH.

According to another aspect, a method in a network node configured to communicate with a wireless device (WD) is described. The WD has been activated and indicated with first and second unified transmission configuration indicator (TCI) states for at least one of downlink (DL) reception from and uplink (UL) transmission to first and second transmission and reception points (TRPs), respectively, by the WD. The WD (and/or the network node) is able to perform a single-TRP operation including at least one of transmitting to and receiving from one of the first and second TRPs. The WD (and/or the network node) is able to perform a multi-TRP operation including at least one of transmitting to and receiving from both the first and the second TRPs. Each of the first and the second unified TCI states comprise either a DL TCI state and a UL TCI state, or a joint UL and DL TCI state.

The method comprises determining an indication indicating to the WD to perform one of the single-TRP operation and the multi-TRP operation for one or more physical channels. The determined indication includes at least one of a first dedicated bit field in a downlink related downlink control information, DCI, scheduling a downlink physical channel; a second dedicated bit field in an uplink related DCI scheduling an uplink physical channel; a first TCI bit field in the downlink related DCI, at least one codepoint of the first TCI bit field indicating a single third unified TCI state; and a second TCI bit field in the uplink related DCI, at least one other codepoint of the second TCI bit field indicating a single fourth unified TCI state. The determined indication is transmitted to the WD.

In some embodiments, the first dedicated bit field indicates at least one of the downlink physical channel is transmitted according to the first unified TCI state and is expected to be received according to the first unified TCI state; the downlink physical channel is transmitted according to the second unified TCI state and is expected to be received according to the second unified TCI state; the downlink physical channel is transmitted according to both the first and second unified TCI states and is expected to be received according to both the first and the second unified TCI states; the downlink physical channel is transmitted according to both the first and second unified TCI states starting from the first unified TCI state; and the downlink physical channel is transmitted according to both the first and second unified TCI states starting from the second unified TCI state.

In some other embodiments, the second dedicated bit field indicates at least one of the uplink physical channel is transmitted according to the first unified TCI state; the uplink physical channel is transmitted according to the second unified TCI state; the uplink physical channel is transmitted according to both the first and second unified TCI states; the uplink physical channel is transmitted according to both the first and second unified TCI states starting from the first unified TCI state; and the uplink physical channel is transmitted according to both the first and second unified TCI states starting from the second unified TCI state.

In an embodiment, the third unified TCI state is equal to one of the first and the second unified TCI states.

In another embodiment, the single TRP operation is performed by the WD only for one downlink physical channel scheduled by the same DCI when the single third unified TCI state is indicated by the first TCI bit field.

In some embodiments, the single fourth unified TCI state is one of the first and the second unified TCI states.

In some other embodiments, the single third unified TCI state is not equal to either the first or the second unified TCI state.

In an embodiment, the downlink TCI state comprises information about a first spatial filter to be used for downlink reception.

In another embodiment, the UL TCI state comprises information about a second spatial filter to be used for uplink transmission.

In some embodiments, the joint UL and DL TCI state comprises information about a third spatial filter common to both downlink reception and uplink transmission.

In some other embodiments, the transmitting or the receiving according to a unified TCI state implies transmitting or receiving with a fourth spatial filter associated to the unified TCI state.

In an embodiment, the at least one of the first, the second, the third, and the fourth spatial filters is defined by a reference signal associated to a quasi-colocation type D.

In another embodiment, the first and the second unified TCI states correspond to a first common beam associated with the first TRP and a second common beam associated with the second TRP, respectively.

In some embodiments, the downlink related DCI is one of a DCI format 1_1 and a DCI format 1_2.

In some other embodiments, the uplink related DCI is one of another DCI format 0_1 and another DCI format 0_2.

In an embodiment, the first dedicated bit field is different than the first TCI bit field.

In an embodiment, the single TRP operation is performed by the WD when a single unified TCI state is indicated by the first TCI bit field.

In some embodiments, the single TRP operation is performed by the WD only for one uplink physical channel scheduled by the DCI.

In some other embodiments, the multi-TRP operation is performed by the WD when two unified TCI states are indicated by the first TCI bit field.

In an embodiment, the multi-TRP operation is applied to all of the one or more physical channels.

In an embodiment, the downlink physical channel is a downlink physical shared channel, PDSCH, and the uplink physical channel is an uplink physical shared channel, PUSCH.

In some embodiments, the one or more physical channels is one or more of one PDSCH, one PUSCH, and one PUCCH.

According to one aspect, a wireless device (WD) configured to communicate with a network node is described. The WD has been activated and indicated with first and second unified transmission configuration indicator (TCI) states for at least one of downlink (DL) reception from and uplink (UL) transmission to first and second transmission and reception points (TRPs), respectively, by the WD. The WD (and/or the network node) is able to perform a single-TRP operation including at least one of transmitting to and receiving from one of the first and second TRPs. The WD (and/or the network node) is able to perform a multi-TRP operation including at least one of transmitting to and receiving from both the first and the second TRPs. Each of the first and the second unified TCI states comprise either a DL TCI state and a UL TCI state, or a joint UL and DL TCI state.

The WD comprises a radio interface configured to receive an indication indicating to the WD to perform one of the single-TRP operation and the multi-TRP operation for one or more physical channels, the received indication including at least one of a first dedicated bit field in a downlink related downlink control information, DCI, scheduling a downlink physical channel; a second dedicated bit field in an uplink related DCI scheduling an uplink physical channel; a first TCI bit field in the downlink related DCI, at least one codepoint of the first TCI bit field indicating a single third unified TCI state; and a second TCI bit field in the uplink related DCI, at least one other codepoint of the second TCI bit field indicating a single fourth unified TCI state. The WD further comprises processing circuitry in communication with the radio interface, where the processing circuitry is configured to perform one of the single-TRP operation and the multi-TRP operation based on the received indication.

In some embodiments, the first dedicated bit field indicates at least one of the downlink physical channel is transmitted according to the first unified TCI state and is expected to be received according to the first unified TCI state; the downlink physical channel is transmitted according to the second unified TCI state and is expected to be received according to the second unified TCI state; the downlink physical channel is transmitted according to both the first and second unified TCI states and is expected to be received according to both the first and the second unified TCI states; the downlink physical channel is transmitted according to both the first and second unified TCI states starting from the first unified TCI state; and the downlink physical channel is transmitted according to both the first and second unified TCI states starting from the second unified TCI state.

In some other embodiments, the second dedicated bit field indicates at least one of the uplink physical channel is transmitted according to the first unified TCI state; the uplink physical channel is transmitted according to the second unified TCI state; the uplink physical channel is transmitted according to both the first and second unified TCI states; the uplink physical channel is transmitted according to both the first and second unified TCI states starting from the first unified TCI state; and the uplink physical channel is transmitted according to both the first and second unified TCI states starting from the second unified TCI state.

In an embodiment, the third unified TCI state is equal to one of the first and the second unified TCI states.

In another embodiment, the single TRP operation is performed by the WD only for one downlink physical channel scheduled by the same DCI when the single third unified TCI state is indicated by the first TCI bit field.

In some embodiments, the single fourth unified TCI state is one of the first and the second unified TCI states.

In some other embodiments, the single third unified TCI state is not equal to either the first or the second unified TCI state.

In an embodiment, the downlink TCI state comprises information about a first spatial filter to be used for downlink reception.

In another embodiment, the UL TCI state comprises information about a second spatial filter to be used for uplink transmission.

In some embodiments, the joint UL and DL TCI state comprises information about a third spatial filter common to both downlink reception and uplink transmission.

In some other embodiments, the transmitting or the receiving according to a unified TCI state implies transmitting or receiving with a fourth spatial filter associated to the unified TCI state.

In an embodiment, the at least one of the first, the second, the third, and the fourth spatial filters is defined by a reference signal associated to a quasi-colocation type D.

In another embodiment, the first and the second unified TCI states correspond to a first common beam associated with the first TRP and a second common beam associated with the second TRP, respectively.

In some embodiments, the downlink related DCI is one of a DCI format 1_1 and a DCI format 1_2.

In some other embodiments, the uplink related DCI is one of another DCI format 0_1 and another DCI format 0_2.

In an embodiment, the first dedicated bit field is different than the first TCI bit field.

In an embodiment, the single TRP operation is performed by the WD when a single unified TCI state is indicated by the first TCI bit field.

In some embodiments, the single TRP operation is performed by the WD only for one uplink physical channel scheduled by the DCI.

In some other embodiments, the multi-TRP operation is performed by the WD when two unified TCI states are indicated by the first TCI bit field.

In an embodiment, the multi-TRP operation is applied to all of the one or more physical channels.

In an embodiment, the downlink physical channel is a downlink physical shared channel, PDSCH, and the uplink physical channel is an uplink physical shared channel, PUSCH.

In some embodiments, the one or more physical channels is one or more of one PDSCH, one PUSCH, and one PUCCH.

According to another aspect, a method in a wireless device (WD) configured to communicate with a network node is described. The WD has been activated and indicated with first and second unified transmission configuration indicator (TCI) states for at least one of downlink (DL) reception from and uplink (UL) transmission to first and second transmission and reception points (TRPs), respectively, by the WD. The WD (and/or the network node) is able to perform a single-TRP operation including at least one of transmitting to and receiving from one of the first and second TRPs. The WD (and/or the network node) is able to perform a multi-TRP operation including at least one of transmitting to and receiving from both the first and the second TRPs. Each of the first and the second unified TCI states comprise either a DL TCI state and a UL TCI state, or a joint UL and DL TCI state.

The method comprises receiving an indication indicating to the WD to perform one of the single-TRP operation and the multi-TRP operation for one or more physical channels, the received indication including at least one of a first dedicated bit field in a downlink related downlink control information, DCI, scheduling a downlink physical channel; a second dedicated bit field in an uplink related DCI scheduling an uplink physical channel; a first TCI bit field in the downlink related DCI, at least one codepoint of the first TCI bit field indicating a single third unified TCI state; and a second TCI bit field in the uplink related DCI, at least one other codepoint of the second TCI bit field indicating a single fourth unified TCI state. The method further comprises performing one of the single-TRP operation and the multi-TRP operation based on the received indication.

In some embodiments, the first dedicated bit field indicates at least one of the downlink physical channel is transmitted according to the first unified TCI state and is expected to be received according to the first unified TCI state; the downlink physical channel is transmitted according to the second unified TCI state and is expected to be received according to the second unified TCI state; the downlink physical channel is transmitted according to both the first and second unified TCI states and is expected to be received according to both the first and the second unified TCI states; the downlink physical channel is transmitted according to both the first and second unified TCI states starting from the first unified TCI state; and the downlink physical channel is transmitted according to both the first and second unified TCI states starting from the second unified TCI state.

In some other embodiments, the second dedicated bit field indicates at least one of the uplink physical channel is transmitted according to the first unified TCI state; the uplink physical channel is transmitted according to the second unified TCI state; the uplink physical channel is transmitted according to both the first and second unified TCI states; the uplink physical channel is transmitted according to both the first and second unified TCI states starting from the first unified TCI state; and the uplink physical channel is transmitted according to both the first and second unified TCI states starting from the second unified TCI state.

In an embodiment, the third unified TCI state is equal to one of the first and the second unified TCI states.

In another embodiment, the single TRP operation is performed by the WD only for one downlink physical channel scheduled by the same DCI when the single third unified TCI state is indicated by the first TCI bit field.

In some embodiments, the single fourth unified TCI state is one of the first and the second unified TCI states.

In some other embodiments, the single third unified TCI state is not equal to either the first or the second unified TCI state.

In an embodiment, the downlink TCI state comprises information about a first spatial filter to be used for downlink reception.

In another embodiment, the UL TCI state comprises information about a second spatial filter to be used for uplink transmission.

In some embodiments, the joint UL and DL TCI state comprises information about a third spatial filter common to both downlink reception and uplink transmission.

In some other embodiments, the transmitting or the receiving according to a unified TCI state implies transmitting or receiving with a fourth spatial filter associated to the unified TCI state.

In an embodiment, the at least one of the first, the second, the third, and the fourth spatial filters is defined by a reference signal associated to a quasi-colocation type D.

In another embodiment, the first and the second unified TCI states correspond to a first common beam associated with the first TRP and a second common beam associated with the second TRP, respectively.

In some embodiments, the downlink related DCI is one of a DCI format 1_1 and a DCI format 1_2.

In some other embodiments, the uplink related DCI is one of another DCI format 0_1 and another DCI format 0_2.

In an embodiment, the first dedicated bit field is different than the first TCI bit field.

In an embodiment, the single TRP operation is performed by the WD when a single unified TCI state is indicated by the first TCI bit field.

In some embodiments, the single TRP operation is performed by the WD only for one uplink physical channel scheduled by the DCI.

In some other embodiments, the multi-TRP operation is performed by the WD when two unified TCI states are indicated by the first TCI bit field.

In an embodiment, the multi-TRP operation is applied to all of the one or more physical channels.

In an embodiment, the downlink physical channel is a downlink physical shared channel, PDSCH, and the uplink physical channel is an uplink physical shared channel, PUSCH.

In some embodiments, the one or more physical channels is one or more of one PDSCH, one PUSCH, and one PUCCH.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of two-stage TCI state update;

FIG. 2 illustrates an example of TCI States Activation/Deactivation for WD-specific PDSCH MAC CE;

FIG. 3 illustrates an example of DCI indication of a TCI state where the DCI gives a pointer into the ordered list of activated TCI states;

FIG. 4 illustrates an example of enhanced TCI States Activation/Deactivation for WD-specific PDSCH MAC CE;

FIG. 5 illustrates an example of NC-JT supported in NR Release-16 where a single CW is transmitted over two TRPs;

FIG. 6 illustrates an example of data transmission over multiple TRPs with FDMSchemeA;

FIG. 7 illustrates an example of data transmission over multiple TRPs with FDMSchemeB;

FIG. 8 illustrates an example of data transmission over multiple TRPs with mini-slot based TDMschemeA;

FIG. 9 illustrates an example of slot based TDM scheme for PDSCH transmissions over multiple TRPs;

FIG. 10 illustrates an example of PUSCH repetitions to two TRPs;

FIG. 11 is a schematic diagram of an example network architecture illustrating a communication system connected via an intermediate network to a host computer according to the principles in the present disclosure;

FIG. 12 is a block diagram of a host computer communicating via a network node with a wireless device over an at least partially wireless connection according to some embodiments of the present disclosure;

FIG. 13 is a flowchart illustrating example methods implemented in a communication system including a host computer, a network node and a wireless device for executing a client application at a wireless device according to some embodiments of the present disclosure;

FIG. 14 is a flowchart illustrating example methods implemented in a communication system including a host computer, a network node and a wireless device for receiving user data at a wireless device according to some embodiments of the present disclosure;

FIG. 15 is a flowchart illustrating example methods implemented in a communication system including a host computer, a network node and a wireless device for receiving user data from the wireless device at a host computer according to some embodiments of the present disclosure;

FIG. 16 is a flowchart illustrating example methods implemented in a communication system including a host computer, a network node and a wireless device for receiving user data at a host computer according to some embodiments of the present disclosure;

FIG. 17 is a flowchart of an example process in a network node according to some embodiments of the present disclosure;

FIG. 18 is a flowchart of an example process in a wireless device according to some embodiments of the present disclosure;

FIG. 19 is a flowchart of an example process in a network node according to some embodiments of the present disclosure;

FIG. 20 is a flowchart of an example process in a wireless device according to some embodiments of the present disclosure;

FIG. 21 illustrates an example of activated TCI states and their association to TCI field codepoints in DCI for separate DL/UL TCI operation for single TRP operation according to some embodiments;

FIG. 22 illustrates an example of activated TCI states and their association to TCI field codepoints in DCI for separate DL/UL TCI operation for multi TRP operation according to some embodiments;

FIG. 23 illustrates an example of activated TCI states and their association to TCI field codepoints in DCI for separate DL/UL TCI operation for single TRP operation according to some embodiments;

FIG. 24 illustrates an example of activated TCI states and their association to TCI field codepoints in DCI for separate DL/UL TCI operation for multi TRP operation according to some embodiments;

FIG. 25 illustrates an example of activated DL TCI states and their association to TCI field codepoints in DCI for Joint DL/UL TCI indication, where a TCI field codepoint is associated with either one or two DL TCI states (which could be used to dynamically switch between single-TRP and multi-TRP operation for DL and/or UL) according to some embodiments;

FIG. 26 illustrates an example of activated TCI states and their association to TCI field codepoints in DCI for Separate DL/UL TCI, where a TCI field codepoint is associated with either one or two DL TCI states and either one or two UL TCI states (which could be used to dynamically switch between single-TRP and multi-TRP operation for DL and/or UL) according to some embodiments;

FIG. 27 illustrates an example mapping between codepoints and the single-TRP/multi-TRP operation according to some embodiments;

FIG. 28 illustrates an example of how the mapping between codepoints and the single-TRP/multi-TRP operation according to some embodiments;

FIG. 29 illustrates an example of TCI field codepoints divided into two groups, where one group is used to update the applied DL TCI state for the common beam, and the other group is used to update the applied DL TCI state for a triggered PDSCH transmission according to some embodiments; and

FIG. 30 illustrates an example of two TCI field codepoints, where TCI field codepoint is used to update the applied DL TCI state for the common beam, and the other TCI field codepoint is used to update the applied DL TCI state for a triggered PDSCH transmission according to some embodiments.

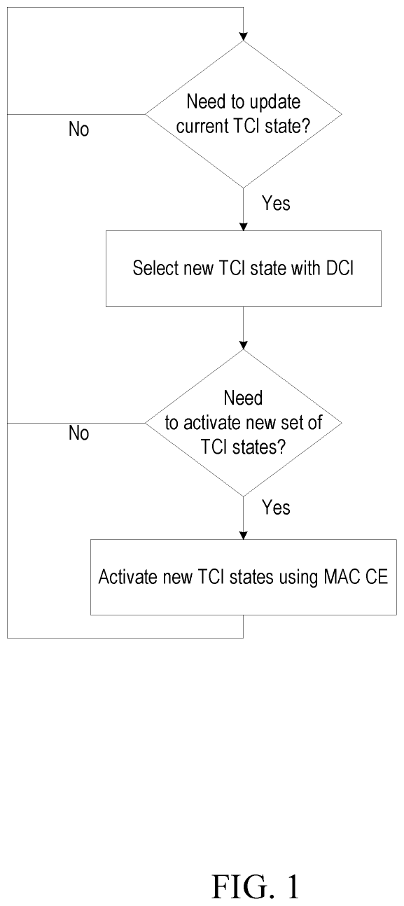

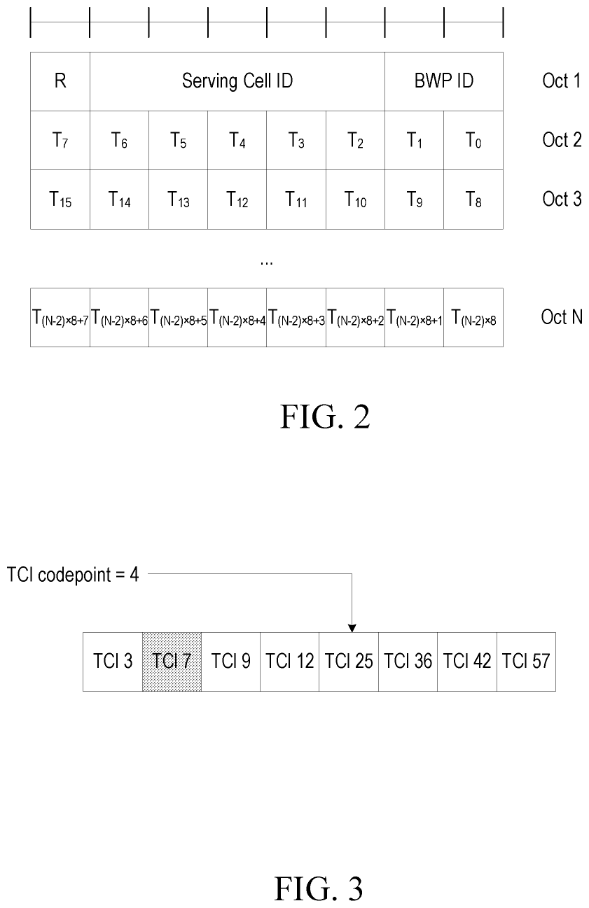

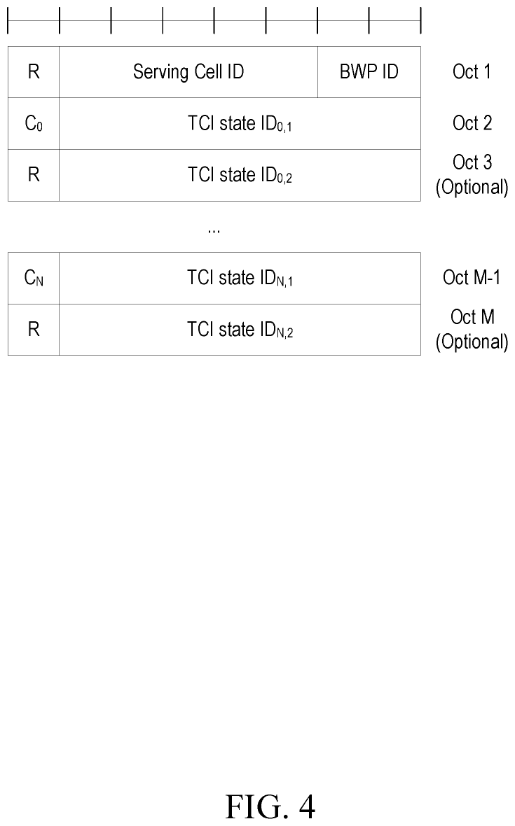

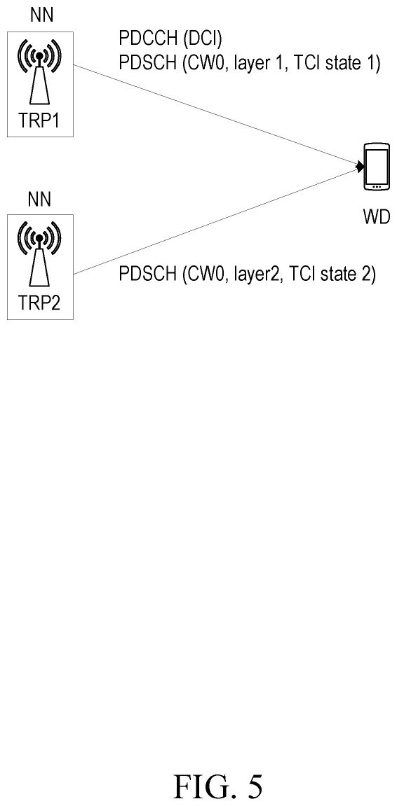

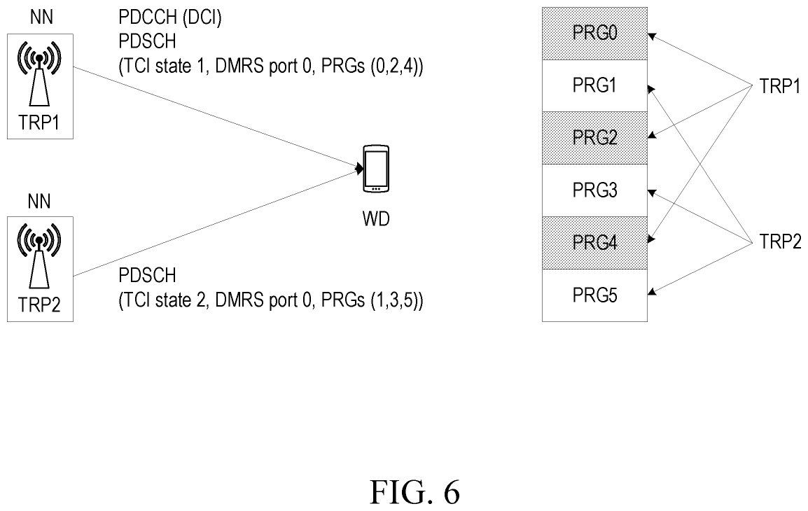

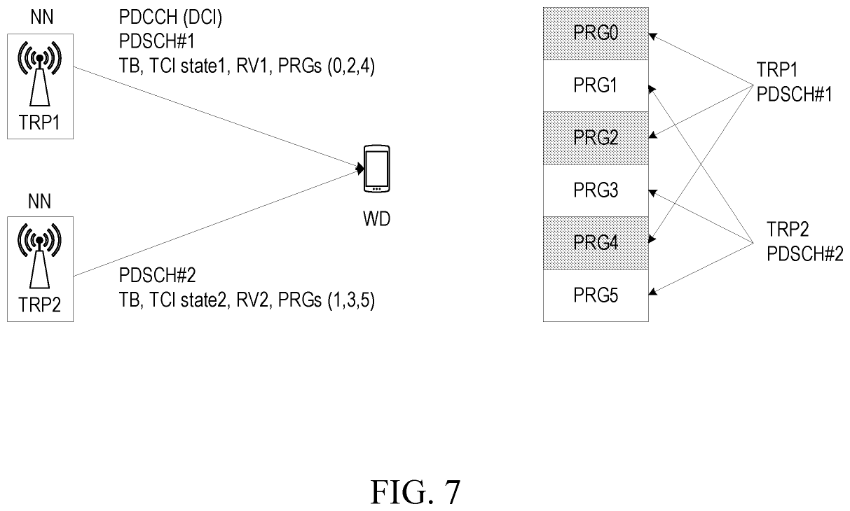

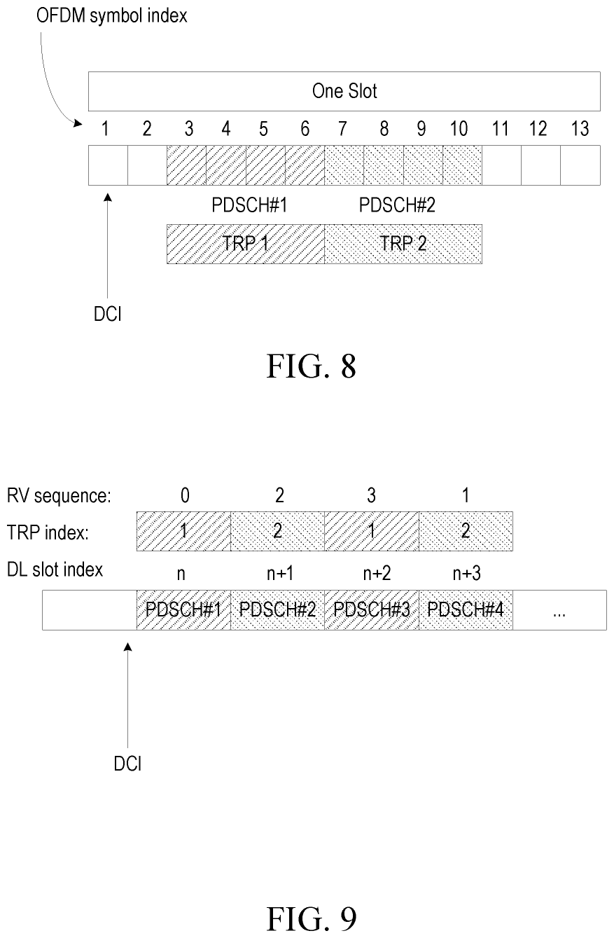

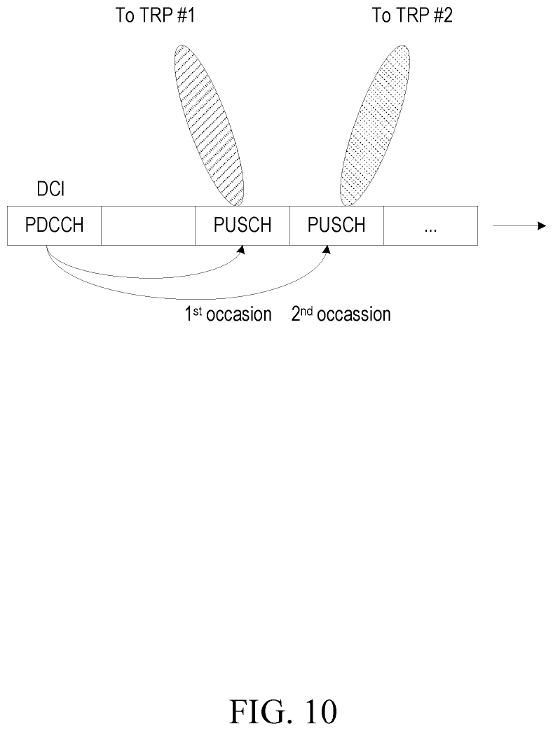

### DETAILED DESCRIPTION

The present disclosure describes one or more of the following embodiments:
a first embodiment covers how to implicitly switch between single-TRP and multi-TRP operation for a unified TCI state framework; and/or
a second embodiment covers how to explicitly switch between single-TRP and multi-TRP operation for the unified TCI state framework.

Some embodiments may include a method for dynamic switching between using one or multiple DL/UL TCI states (or Joint DL/UL TCI States) for PDSCH reception and/or PUSCH/PUCCH transmission. The method may include one or more of the following steps:
Step 1: Configuring from network to WD a list of DL/UL TCI states (or joint DL/UL TCI states) via higher layer configuration (RRC configuration) to the WD.
Step 2: Activating a subset of configured list of DL/UL TCI states (or joint DL/UL TCI states) via MAC CE signaling from the network to the WD, where a codepoint in TCI field in DCI may be mapped to one or more DL/UL TCI states (or joint DL/UL TCI states),
Step 3: Indicating/Updating N≥1 DL/UL TCI states (or joint DL/UL TCI states) out of the activated TCI states to a WD from the network node via a TCI field codepoint in a DCI, wherein the N TCI states are to be used for subsequent DL reception and/or UL transmission.
Step 4: Depending on the number, N, of DL/UL TCI states (or joint DL/UL TCI states) updated in Step 3, perform the following actions:
   if N=1 DL/UL TCI state (or joint DL/UL TCI state) is updated in step 3, then the indicated single DL/UL TCI state (or joint DL/UL TCI state) is applied for PDSCH reception and/or PUSCH/PUCCH transmission; and/or
   if N>1 DL/UL TCI states (or joint DL/UL TCI states) is updated in step 3, then the indicated N>1 DL/UL TCI state (or joint DL/UL TCI state) are applied for PDSCH reception and/or PUSCH/PUCCH transmission.
Step 5: Using the applied DL/UL TCI states (or joint DL/UL TCI states) to perform one or more of receiving PDSCH, transmitting PUSCH, and/or transmitting PUCCH.

Some embodiments of the present disclosure extend the unified TCI framework to support dynamic switching between single-TRP and multi-TRP operation. Some embodiments provide a common mechanism (either using the TCI field present in DL related DCI or using the TCI field present in UL related DCI) for achieving dynamic switching between single-TRP and multi-TRP operation for more than one of PDSCH, PUSCH, and PUCCH. Although the TCI field present in DL or UL related DCI may be used for dynamic switching, some embodiments provide independent switching of single-TRP versus multi-TRP for PDSCH, PUSCH, and/or PUCCH, e.g., depending on the number of DL/UL TCI states indicated by the codepoint in the TCI field of the DL or UL related DCI. That is, some embodiments of the proposed solutions provide reduced signaling overhead while at the same time providing flexibility of independent dynamic switching for UL and DL.

Before describing in detail example embodiments, it is noted that the embodiments reside primarily in combinations of apparatus components and processing steps related to or dynamic switching of spatial filter for multi-TRP systems. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second.” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), a multiple transmit/receive point (TRP), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD. Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Generally, it may be considered that the network, e.g., a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g., information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages. It may be considered that receiving control signaling comprises demodulating and/or decoding and/or detecting, e.g., blind detection of, one or more messages, in particular a message carried by the control signaling, e.g., based on an assumed set of resources, which may be searched and/or listened for the control information. It may be assumed that both sides of the communication are aware of the configurations, and may determine the set of resources, e.g., based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A channel may generally be a logical, transport or physical channel (e.g., a physical channel between a network node and a WD, between any other devices, etc.). A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction. Examples of channels comprise a channel for low latency and/or high reliability transmission, in particular a channel for Ultra-Reliable Low Latency Communication (URLLC), which may be for control and/or data. In some embodiments, the channel described herein may be an uplink channel and in further embodiments may be a physical uplink shared channel (PUSCH) and in yet further embodiments may be a flexible PUSCH.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., WD) may comprise configuring the WD to perform certain measurements on certain subframes or radio resources and reporting such measurements according to embodiments of the present disclosure.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

It may be considered for cellular communication there is provided at least one uplink (UL) connection and/or channel and/or carrier and at least one downlink (DL) connection and/or channel and/or carrier, e.g., via and/or defining a cell, which may be provided by a network node, in particular a base station or gNodeB. An uplink direction may refer to a data transfer direction from a terminal to a network node, e.g., base station and/or relay station. A downlink direction may refer to a data transfer direction from a network node, e.g., base station and/or relay node, to a terminal. UL and DL may be associated to different frequency resources, e.g., carriers and/or spectral bands. A cell may comprise at least one uplink carrier and at least one downlink carrier, which may have different frequency bands. A network node, e.g., a base station or eNodeB, may be adapted to provide and/or define and/or control one or more cells, e.g., a PCell and/or a LA cell.

In some embodiments, a multiple transmit/receive point (TRP) may be referred to as a network node. In some other embodiments, a TRP may refer to a spatial relation and/or a Transmission Configuration Indicator (TCI) state. In one or more embodiments, a TRP may be represented by a TCI state. In some embodiments, a TRP may be use multiple TCI states such as to perform communication (and/or network node) functions described herein. In some embodiments, a TRP may be a part of a network node (e.g., gNB) transmitting and receiving radio signals to/from a WD such as according to physical layer properties and/or parameters (e.g., inherent to an element).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for dynamic switching of spatial filter for multi-TRP systems.

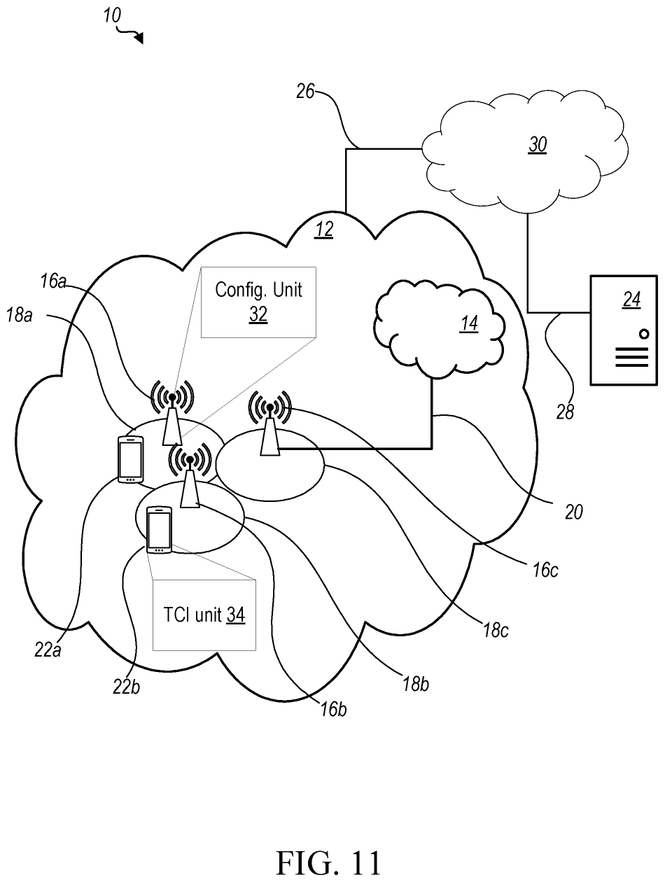

Referring again to the drawing figures, in which like elements are referred to by like reference numerals, there is shown in FIG. 11 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 11 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration (config) unit 32 which is configured to one or more of: transmit a configuration comprising a list of TCI states; activate a subset of the list of TCI states via MAC CE signaling to the WD 22, one or more of the TCI states being mapped to a single codepoint; update a number, N, of the TCI states via DCI signaling to the WD 22; and communicate with the WD 22 using at least one of the TCI states based on the number N.

A wireless device 22 is configured to include a TCI unit 34 which is configured to one or more of: receive a configuration comprising a list of TCI states; receive an activation of a subset of the list of TCI states via MAC CE signaling, one or more of the TCI states being mapped to a single codepoint; receive DCI signaling updating a number, N, of the TCI states; and communicate with the network node using at least one of the TCI states based on the number N.

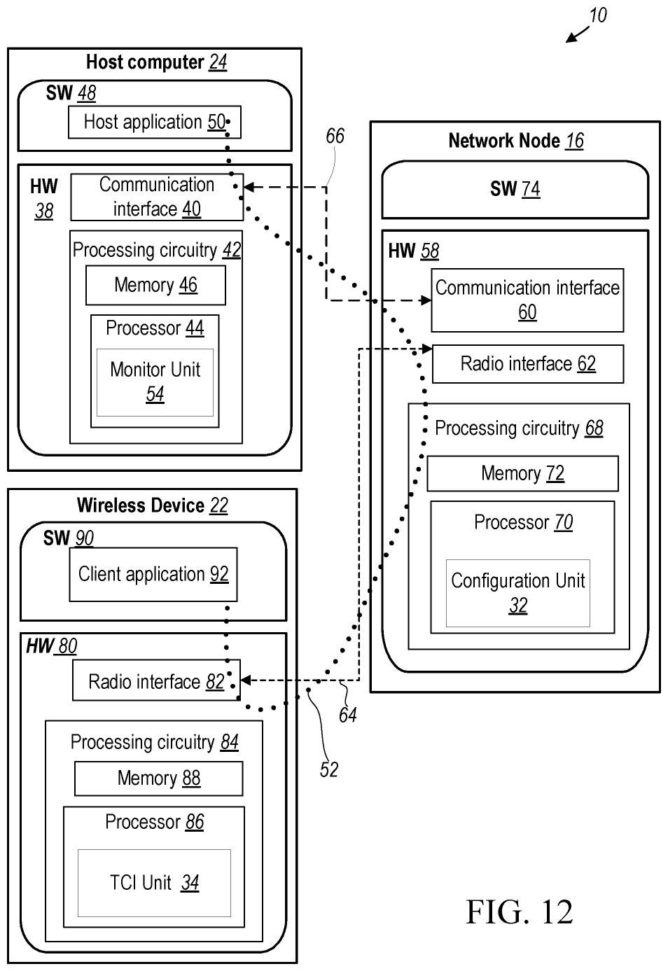

Example implementations, in accordance with an embodiment, of the WD 22, network node 16 and host computer 24 discussed in the preceding paragraphs will now be described with reference to FIG. 12. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include config. unit 32 configured to perform network node methods discussed herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a TCI unit 34 configured to perform WD methods discussed herein.

In some embodiments, the inner workings of the network node 16, WD 22, and host computer 24 may be as shown in FIG. 12 and independently, the surrounding network topology may be that of FIG. 11.

In FIG. 12, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 11 and 12 show various “units” such as config. unit 32, and TCI unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

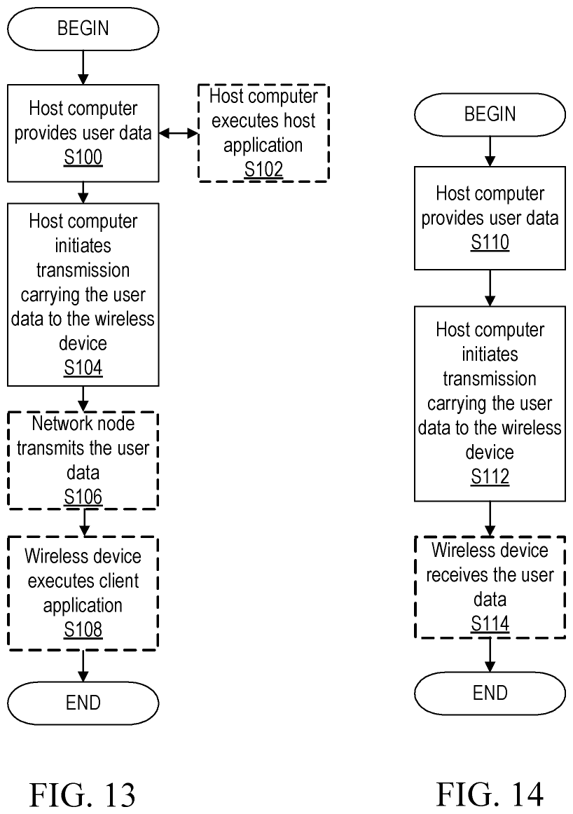

FIG. 13 is a flowchart illustrating an example method implemented in a communication system, such as, for example, the communication system of FIGS. 11 and 12, in accordance with one embodiment. The communication system may include a host computer 24, a network node 16 and a WD 22, which may be those described with reference to FIG. 12. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 14 is a flowchart illustrating an example method implemented in a communication system, such as, for example, the communication system of FIG. 11, in accordance with one embodiment. The communication system may include a host computer 24, a network node 16 and a WD 22, which may be those described with reference to FIGS. 11 and 12. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

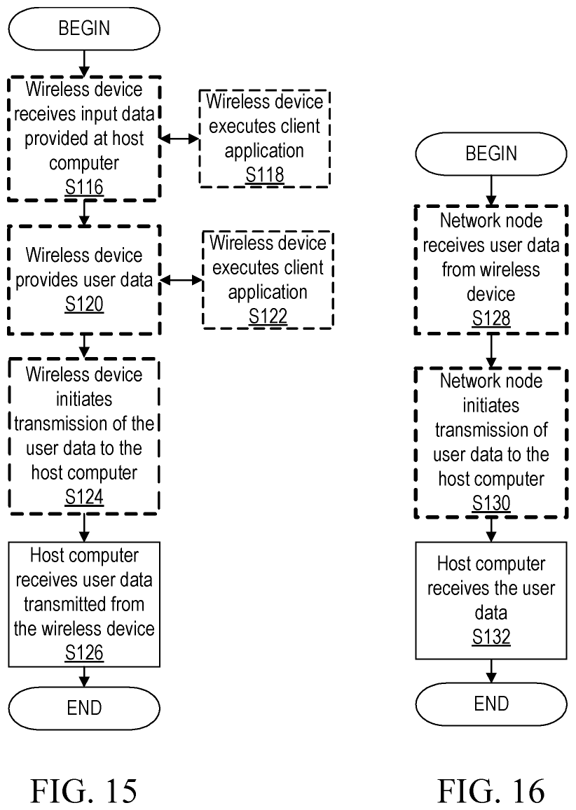

FIG. 15 is a flowchart illustrating an example method implemented in a communication system, such as, for example, the communication system of FIG. 11, in accordance with one embodiment. The communication system may include a host computer 24, a network node 16 and a WD 22, which may be those described with reference to FIGS. 11 and 12. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 16 is a flowchart illustrating an example method implemented in a communication system, such as, for example, the communication system of FIG. 11, in accordance with one embodiment. The communication system may include a host computer 24, a network node 16 and a WD 22, which may be those described with reference to FIGS. 11 and 12. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

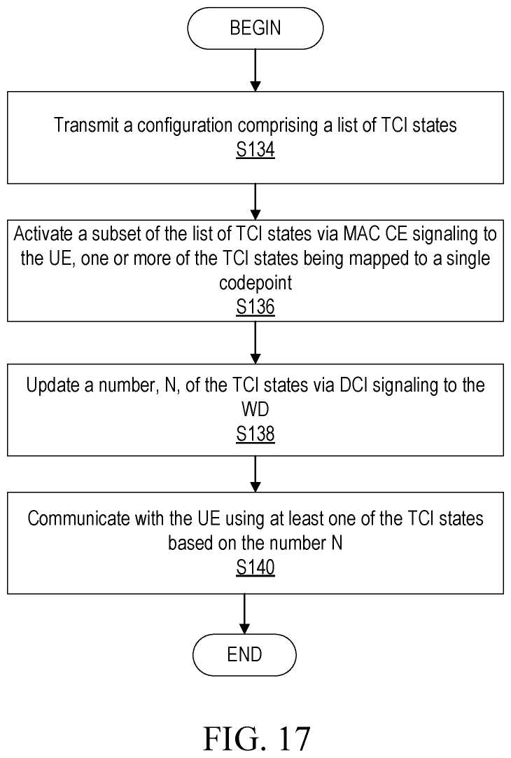

FIG. 17 is a flowchart of an example process in a network node 16 according to some embodiments of the present disclosure. One or more Blocks and/or functions and/or methods performed by the network node 16 may be performed by one or more elements of network node 16 such as by config. unit 32 in processing circuitry 68, processor 70, radio interface 62, etc. according to the example method. Network node 16 such as by config. unit 32 in processing circuitry 68, processor 70 and/or radio interface 62, is configured to transmit (Block S134) a configuration comprising a list of TCI states. Network node 16 such as by config. unit 32 in processing circuitry 68, processor 70 and/or radio interface 62, is configured to activate (Block S136) a subset of the list of TCI states via MAC CE signaling to the WD 22, one or more of the TCI states being mapped to a single codepoint. Network node 16 such as by config. unit 32 in processing circuitry 68, processor 70 and/or radio interface 62, is configured to update (Block S138) a number, N, of the TCI states via DCI signaling to the WD 22. Network node 16 such as by config. unit 32 in processing circuitry 68, processor 70 and/or radio interface 62, is configured to communicate (Block S140) with the WD 22 using at least one of the TCI states based on the number N.

In some embodiments, network node 16 such as by config. unit 32 in processing circuitry 68, processor 70 and/or radio interface 62, is configured to communicate with the WD 22 using the at least one of the TCI states based on whether N is one of (i) equal to and (ii) greater than 1. In some embodiments, network node 16 such as by config. unit 32 in processing circuitry 68, processor 70 and/or radio interface 62, is configured to communicate with the WD 22 using the at least one of the TCI states by being configured to: if N=1 TCI state is updated, apply the indicated TCI state to a PDSCH and/or PUSCH/PUCCH; and if N>=TCI states is updated, apply the indicated TCI states to the PDSCH and/or PUSCH/PUCCH.

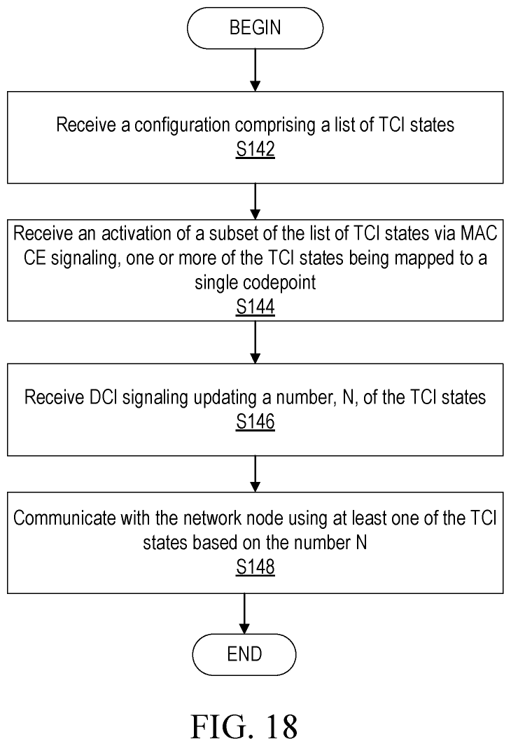

FIG. 18 is a flowchart of an example process in a wireless device 22 according to some embodiments of the present disclosure. One or more Blocks and/or functions and/or methods performed by WD 22 may be performed by one or more elements of WD 22 such as by TCI unit 34 in processing circuitry 84, processor 86, radio interface 82, etc. WD 22 such as by TCI unit 34 in processing circuitry 84, processor 86 and/or radio interface 82, is configured to receive (Block S142) a configuration comprising a list of TCI states. WD 22 such as by TCI unit 34 in processing circuitry 84, processor 86 and/or radio interface 82, is configured to receive (Block S144) an activation of a subset of the list of TCI states via MAC CE signaling, one or more of the TCI states being mapped to a single codepoint. WD 22 such as by TCI unit 34 in processing circuitry 84, processor 86 and/or radio interface 82, is configured to receive (Block S146) DCI signaling updating a number, N, of the TCI states. WD 22 such as by TCI unit 34 in processing circuitry 84, processor 86 and/or radio interface 82, is configured to communicate (Block S148) with the network node using at least one of the TCI states based on the number N.

In some embodiments, WD 22 such as by TCI unit 34 in processing circuitry 84, processor 86 and/or radio interface 82, is configured to communicate with the network node using the at least one of the TCI states based on whether N is one of (i) equal to and (ii) greater than 1.

In some embodiments, WD 22 such as by TCI unit 34 in processing circuitry 84, processor 86 and/or radio interface 82, is configured to communicate with the network node using the at least one of the TCI states by being configured to: if N=1 TCI state is updated, apply the indicated TCI state to a PDSCH reception and/or PUSCH/PUCCH transmission; and if N>=TCI states is updated, apply the indicated TCI states to the PDSCH reception and/or PUSCH/PUCCH transmission.

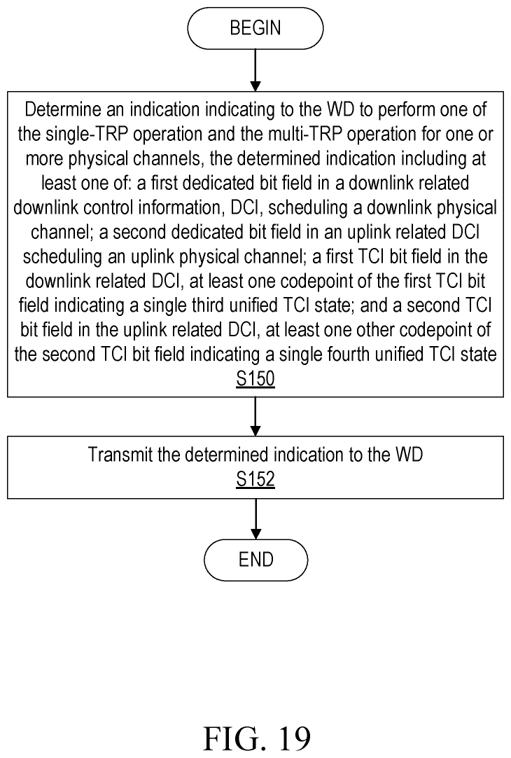

FIG. 19 is a flowchart of an example process in a network node 16 according to some embodiments of the present disclosure. One or more Blocks and/or functions and/or methods performed by the network node 16 may be performed by one or more elements of network node 16 such as by config. unit 32 in processing circuitry 68, processor 70, radio interface 62, etc. according to the example method. Network node 16 such as by config. unit 32 in processing circuitry 68, processor 70 and/or radio interface 62, is configured to determine (Block S150) determine an indication indicating to the WD 22 to perform one of the single-TRP operation and the multi-TRP operation for one or more physical channels. The determined indication including at least one of a first dedicated bit field in a downlink related downlink control information (DCI) scheduling a downlink physical channel; a second dedicated bit field in an uplink related DCI scheduling an uplink physical channel; a first TCI bit field in the downlink related DCI, at least one codepoint of the first TCI bit field indicating a single third unified TCI state; a second TCI bit field in the uplink related DCI, at least one other codepoint of the second TCI bit field indicating a single fourth unified TCI state. Further, network node 16 such as by config. unit 32 in processing circuitry 68, processor 70 and/or radio interface 62, is configured to transmit (Block S152) the determined indication to the WD 22.

In some embodiments, the first dedicated bit field indicates at least one of: the downlink physical channel is transmitted according to the first unified TCI state and is expected to be received according to the first unified TCI state; the downlink physical channel is transmitted according to the second unified TCI state and is expected to be received according to the second unified TCI state; the downlink physical channel is transmitted according to both the first and second unified TCI states and is expected to be received according to both the first and the second unified TCI states; the downlink physical channel is transmitted according to both the first and second unified TCI states starting from the first unified TCI state; and the downlink physical channel is transmitted according to both the first and second unified TCI states starting from the second unified TCI state.

In some other embodiments, the second dedicated bit field indicates at least one of the uplink physical channel is transmitted according to the first unified TCI state; the uplink physical channel is transmitted according to the second unified TCI state; the uplink physical channel is transmitted according to both the first and second unified TCI states; the uplink physical channel is transmitted according to both the first and second unified TCI states starting from the first unified TCI state; and the uplink physical channel is transmitted according to both the first and second unified TCI states starting from the second unified TCI state.

In one embodiment, the third unified TCI state is equal to one of the first and the second unified TCI states.

In another embodiment, the single TRP operation is performed by the WD 22 only for one downlink physical channel scheduled by the same DCI when the single third unified TCI state is indicated by the first TCI bit field.

In some embodiments, the single fourth unified TCI state is one of the first and the second unified TCI states.

In some other embodiments, the single third unified TCI state is not equal to either the first or the second unified TCI state.

In an embodiment, the downlink TCI state comprises information about a first spatial filter to be used for downlink reception.

In another embodiment, the UL TCI state comprises information about a second spatial filter to be used for uplink transmission.

In some embodiments, the joint UL and DL TCI state comprises information about a third spatial filter common to both downlink reception and uplink transmission.

In some other embodiments, the transmitting or the receiving according to a unified TCI state implies transmitting or receiving with a fourth spatial filter associated to the unified TCI state.

In an embodiment, the at least one of the first, the second, the third, and the fourth spatial filters is defined by a reference signal associated to a quasi-colocation type D.

In another embodiment, the first and the second unified TCI states correspond to a first common beam associated with the first TRP and a second common beam associated with the second TRP, respectively.

In some embodiments, the downlink related DCI is one of a DCI format 1_1 and a DCI format 1_2.

In some other embodiments, the uplink related DCI is one of another DCI format 0_1 and another DCI format 0_2.

In an embodiment, the first dedicated bit field is different than the first TCI bit field.

In another embodiment, the single TRP operation is performed by the WD when a single unified TCI state is indicated by the first TCI bit field.

In some embodiments, the single TRP operation is performed by the WD 22 only for one uplink physical channel scheduled by the DCI.

In some other embodiments, the multi-TRP operation is performed by the WD 22 when two unified TCI states are indicated by the first TCI bit field.

In an embodiment, the multi-TRP operation is applied to all of the one or more physical channels.

In another embodiment, the downlink physical channel is a downlink physical shared channel (PDSCH), and the uplink physical channel is an uplink physical shared channel (PUSCH).

In some embodiments, the one or more physical channels is one or more of one PDSCH, one PUSCH, and one PUCCH.

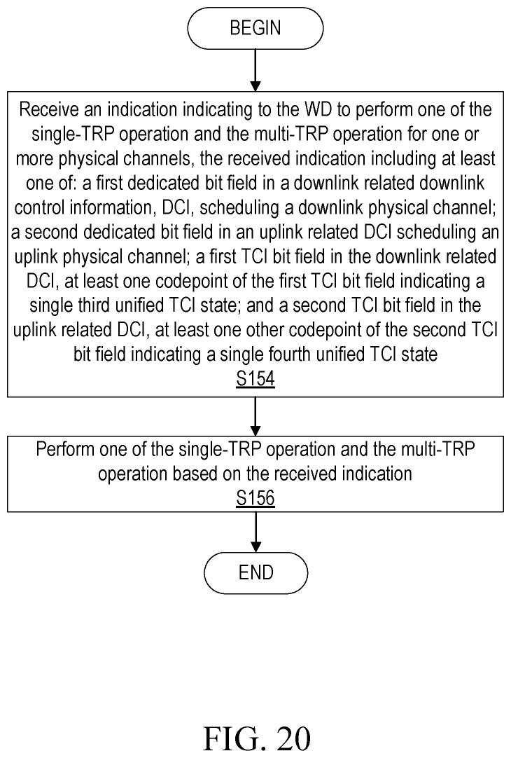

FIG. 20 is a flowchart of an example process in a wireless device 22 according to some embodiments of the present disclosure. One or more Blocks and/or functions and/or methods performed by WD 22 may be performed by one or more elements of WD 22 such as by TCI unit 34 in processing circuitry 84, processor 86, radio interface 82, etc. WD 22 such as by TCI unit 34 in processing circuitry 84, processor 86 and/or radio interface 82, is configured to receive (Block S154) an indication indicating to the WD to perform one of the single-TRP operation and the multi-TRP operation for one or more physical channels. The received indication includes at least one of a first dedicated bit field in a downlink related downlink control information (DCI) scheduling a downlink physical channel; a second dedicated bit field in an uplink related DCI scheduling an uplink physical channel; a first TCI bit field in the downlink related DCI, at least one codepoint of the first TCI bit field indicating a single third unified TCI state; and a second TCI bit field in the uplink related DCI, at least one other codepoint of the second TCI bit field indicating a single fourth unified TCI state. Further, WD 22 such as by TCI unit 34 in processing circuitry 84, processor 86 and/or radio interface 82, is configured to perform (Block S156) one of the single-TRP operation and the multi-TRP operation based on the received indication.

In some embodiments, the first dedicated bit field indicates at least one of: the downlink physical channel is transmitted according to the first unified TCI state and is expected to be received according to the first unified TCI state; the downlink physical channel is transmitted according to the second unified TCI state and is expected to be received according to the second unified TCI state; the downlink physical channel is transmitted according to both the first and second unified TCI states and is expected to be received according to both the first and the second unified TCI states; the downlink physical channel is transmitted according to both the first and second unified TCI states starting from the first unified TCI state; and the downlink physical channel is transmitted according to both the first and second unified TCI states starting from the second unified TCI state.

In some other embodiments, the second dedicated bit field indicates at least one of the uplink physical channel is transmitted according to the first unified TCI state; the uplink physical channel is transmitted according to the second unified TCI state; the uplink physical channel is transmitted according to both the first and second unified TCI states; the uplink physical channel is transmitted according to both the first and second unified TCI states starting from the first unified TCI state; and the uplink physical channel is transmitted according to both the first and second unified TCI states starting from the second unified TCI state.

In one embodiment, the third unified TCI state is equal to one of the first and the second unified TCI states.

In another embodiment, the single TRP operation is performed by the WD 22 only for one downlink physical channel scheduled by the same DCI when the single third unified TCI state is indicated by the first TCI bit field.

In some embodiments, the single fourth unified TCI state is one of the first and the second unified TCI states.

In some other embodiments, the single third unified TCI state is not equal to either the first or the second unified TCI state.

In an embodiment, the downlink TCI state comprises information about a first spatial filter to be used for downlink reception.

In another embodiment, the UL TCI state comprises information about a second spatial filter to be used for uplink transmission.

In some embodiments, the joint UL and DL TCI state comprises information about a third spatial filter common to both downlink reception and uplink transmission.

In some other embodiments, the transmitting or the receiving according to a unified TCI state implies transmitting or receiving with a fourth spatial filter associated to the unified TCI state.

In an embodiment, the at least one of the first, the second, the third, and the fourth spatial filters is defined by a reference signal associated to a quasi-colocation type D.

In another embodiment, the first and the second unified TCI states correspond to a first common beam associated with the first TRP and a second common beam associated with the second TRP, respectively.

In some embodiments, the downlink related DCI is one of a DCI format 1_1 and a DCI format 1_2.

In some other embodiments, the uplink related DCI is one of another DCI format 0_1 and another DCI format 0_2.

In an embodiment, the first dedicated bit field is different than the first TCI bit field.

In another embodiment, the single TRP operation is performed by the WD when a single unified TCI state is indicated by the first TCI bit field.

In some embodiments, the single TRP operation is performed by the WD 22 only for one uplink physical channel scheduled by the DCI.

In some other embodiments, the multi-TRP operation is performed by the WD 22 when two unified TCI states are indicated by the first TCI bit field.

In an embodiment, the multi-TRP operation is applied to all of the one or more physical channels.

In another embodiment, the downlink physical channel is a downlink physical shared channel (PDSCH), and the uplink physical channel is an uplink physical shared channel (PUSCH).

In some embodiments, the one or more physical channels is one or more of one PDSCH, one PUSCH, and one PUCCH.

Having described the general process flow of arrangements of the disclosure and having provided examples of hardware and software arrangements for implementing the processes and functions of the disclosure, the sections below provide details and examples of arrangements for dynamic switching of spatial filter for multi-TRP systems, which may be implemented by the network node 16, wireless device 22 and/or host computer 24.

In some embodiments, TCI states may refer to “DL TCI state” and/or “UL TCI state”. In some other embodiments, “DL TCI state” and/or “UL TCI state” may be referred to as “joint DL/UL TCI state”. In some other embodiments, the term TRP refers to a network node 16.

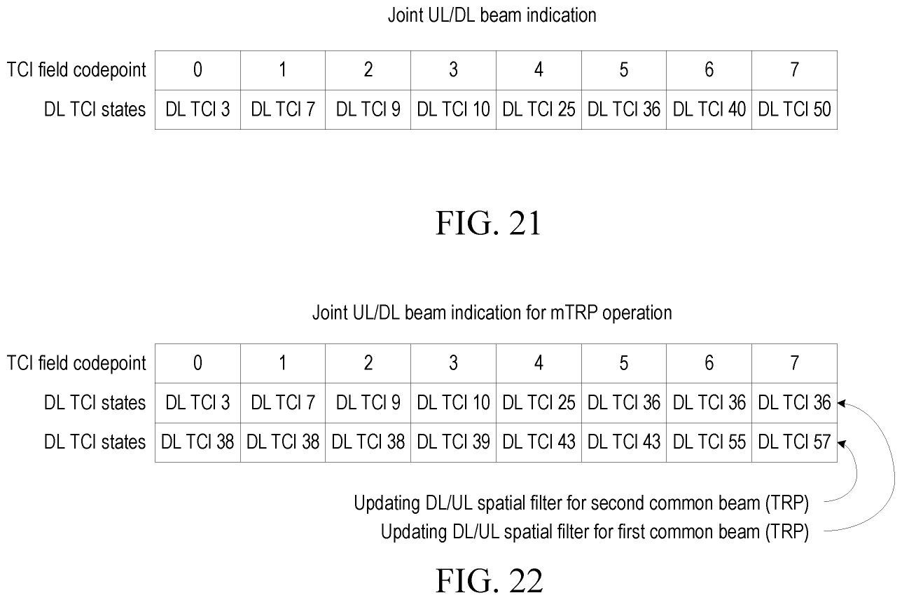

FIG. 21 illustrates a schematic example where a list of activated DL TCI states is mapped to a set of TCI field codepoints in a DCI for Joint DL/UL TCI update for single-TRP based operation. The mapping of DL TCI states to codepoints in the TCI field may be performed using MAC CE. A codepoint of the TCI field in DCI may be used to update a DL TCI state, which may be used by the WD 22 to determine TX/RX one or more spatial filters for both DL and UL signals/channels. For example, in case codepoint 2 is indicated to the WD 22, the WD 22 may (e.g., may be triggered by the indication to) update its TX/RX spatial filters based on DL TCI state 9 for both DL and UL signals/channels.

FIG. 22 illustrates a schematic example where a list of activated DL TCI state pairs is mapped to a set of TCI field codepoints in a DCI for Joint DL/UL TCI update for multi-TRP based operation. A single TCI field codepoint in DCI may be used to update two DL TCI states, which may be used (e.g., by WD 22) to determine two TX/RX spatial filters for both DL and UL signals/channels (e.g., one spatial filter per TRP). For example, in case a DCI with TCI field codepoint 2 is indicated to the WD 22, the WD 22 may (e.g., may be triggered by the indication to) update one TX/RX spatial filter based on DL TCI state 9 for both DL and UL signals/channels associated to a first TRP, and another TX/RX spatial filter based on DL TCI state 38 for both DL and UL signals/channels associated to a second TRP.

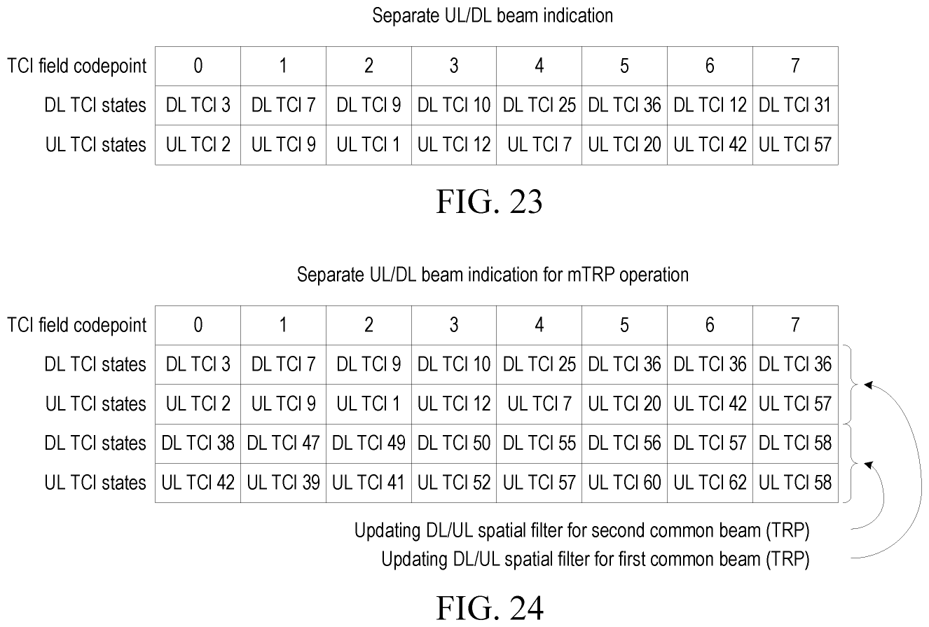

FIG. 23 illustrates a schematic example of how a list of activated DL/UL TCI states and their association to TCI field codepoints in DCI may be used (e.g., by WD 22) to look for (e.g., search, determine) separate DL/UL TCIs for single-TRP operation. Each TCI field codepoint in DCI may be associated with one DL TCI state and one UL TCI state. When a WD 22 is indicated with a TCI field codepoint that is mapped to one DL TCI state and one UL TCI state, the WD 22 may apply one DL TCI state and one UL TCI state (e.g., to determine one or more spatial filters and/or communicate with one or more TRPs, network nodes 16, etc.).

FIG. 24 illustrates a schematic example of a list of activated DL/UL TCI states and their association to TCI field codepoints in DCI, which may be used (e.g., by WD 22) to look for (e.g., search, determine) separate DL/UL TCIs for multi-TRP operation. Teach TCI field codepoint in DCI may be associated with two (or more) DL TCI states and two (or more) UL TCI states. A single TCI field codepoint in DCI may be used to update two (or more) DL TCI states and two (or more) UL TCI states. The two (or more) DL TCI states and two (or more) UL TCI states may be used to determine two (or more) RX spatial filters for DL signals/channels (e.g., one DL spatial filter per TRP) and two (or more) TX spatial filters for UL signals/channels (e.g., one UL spatial filter per TRP). For example, if a DCI with TCI field codepoint 2 is indicated to the WD 22, the WD 22 may update one RX spatial filter based on DL TCI state 9 for DL signals/channels from a first TRP, one RX spatial filter based on DL TCI state 49 for DL signals/channels from a second TRP, one TX spatial filter based on UL TCI state 1 for UL signals/channels from a first TRP and one TX spatial filter based on UL TCI state 41 for UL signals/channels from a second TRP.

In some other embodiments, in Multiple Transmit/Receive Point (multi-TRP) operation, a serving cell may be configured to schedule a WD 22 from (and/or to communicate with at least) two TRPs (e.g., network nodes 16), which may provide better PDSCH coverage, reliability and/or data rates (e.g., when compared to scheduling the WD 22 to communicate with only one TRP).

In some embodiments, two different operation modes for multi-TRP may be used, e.g., single-DCI and multi-DCI. In some other embodiments, for one or both modes, control of uplink and/or downlink operation is performed by physical layer and MAC. In single-DCI mode, WD 22 may be scheduled by the same DCI for both TRPs and in multi-DCI mode. WD 22 may be scheduled by independent DCIs from each TRP. For example, WD 22 may be scheduled by two network nodes 16, where each one of a first network node 16a (e.g., TRP 1) and a second network node 16b (e.g., TRP 2) schedule communication with WD 22 by using independent DCIs. In some other embodiments, a TRP may be represented by a SRS resource set, an SRS field in a UL related DCI, and/or a temporary IP multimedia private identity (TPMI) field in a UL related DCI.

One or more other embodiments are as follows:
Embodiment 1 covers how to implicitly switch between single-TRP and multi-TRP operation using a unified TCI state framework;
Embodiment 2 covers how to explicitly switch between single-TRP and multi-TRP operation using a unified TCI state framework.

The first and second embodiments are described in more detail below.

### Embodiment 1: Implicit Switching Between Single-TRP and Multi-TRP Operation

In this embodiment, dynamic switching between single-TRP and multi-TRP operation for unified TCI state framework may be performed implicitly based on what DL and/or UL TCI states are activated/updated using an indicated TCI field codepoint in DCI. The indicated TCI field codepoint may be signaled to the WD 22 from the network node (NN) 16 in either one or more of:
a DL related DCI (e.g., DCI format 1_1 or DCI format 1_2);
an UL related DCI (e.g., DCI format 0_1 or DCI format 0_2); or
a dedicated DCI format.

Note that the TCI field codepoint may indicate one or more of:
one or more DL TCI states (with each DL TCI state being usable by the WD 22 to determine a single RX spatial filter for downlink reception);
one or more UL TCI states (with each UL TCI state being usable by the WD 22 to determine a single TX spatial filter for uplink transmission); and/or
one or more joint DL/UL TCI states (with each joint DL/UL TCI state being usable by the WD 22 to determine a single pair of TX/RX spatial filters for uplink transmission/downlink reception).

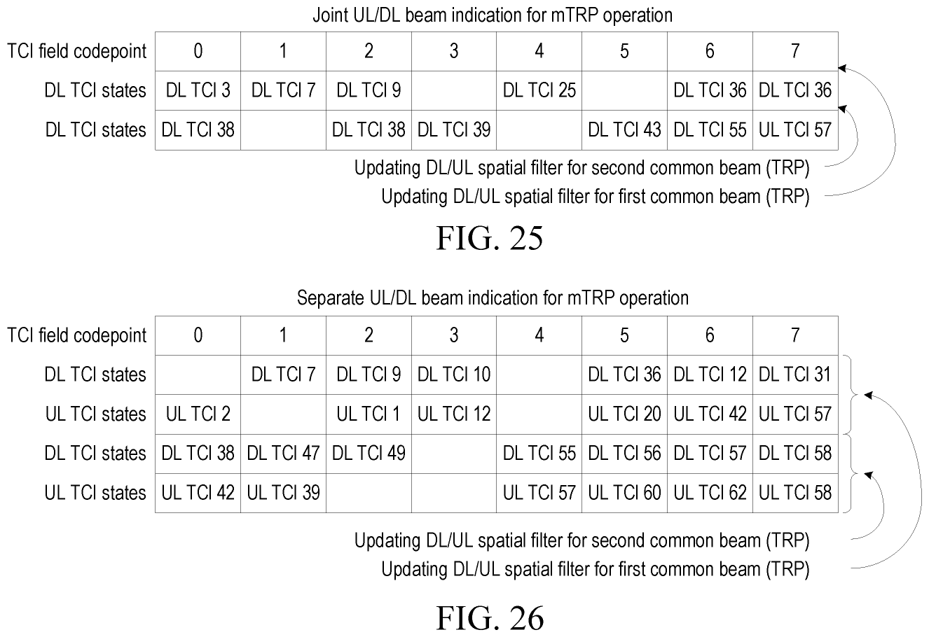

In one embodiment, a joint DL/UL TCI state indication may be used. One or more TCI field codepoints in DCI may be associated with two activated DL TCI states. One or more other TCI field codepoints may be associated with a single activated DL TCI state, e.g., as schematically illustrated in FIG. 25. In case the WD 22 is indicated with (e.g., receives an indication indicating) a TCI field codepoint associated with a single activated DL TCI state, the WD 22 may use the single DL TCI state to determine a single TX/RX spatial filter. The TX spatial filter for UL transmission and/or the RX spatial filter for DL reception may be determined using the single DL TCI state indicated by the TCI field codepoint for single-TRP operation. In case the WD 22 is indicated with a TCI field codepoint associated with (e.g., receives an indication indicating) two activated DL TCI states, the WD 22 may use the two DL TCI states to determine two TX/RX spatial filters. In other words, two TX spatial filters for UL transmission and two RX spatial filters for DL reception may be determined using the two DL TCI states indicated by the TCI field codepoint for multi-TRP operation. By dynamically indicating either a TCI field codepoint associated to a single DL TCI state or a TCI field codepoint associated to two (or more) DL TCI states, the WD 22 may be dynamically indicated to determine either a single TX/RX spatial filter or two (or more) TX/RX spatial filters based on the indicated TCI field codepoint in DCI. The dynamic indication of TCI state(s) and determination of the TX/RX spatial filters by the WD 22 may be referred to as dynamic switching between single TRP operation and multi-TRP operation in this embodiment.

During single-TRP operation, WD 22 may receive one or more physical channels (e.g., a PDSCH, PUSCH and PUCCH) from a network node 16 (e.g., one TRP). During multi-TRP operation, WD 22 may receive one or more physical channels (e.g., PDSCH, PUSCH and PUCCH) may be received from two or more network nodes 16 (e.g., two TRPs) (either using TDM/FDM/SDM combined with for example repetition, diversity, or higher order multiple input multiple output (MIMO)).

In another embodiment, even if two DL TCI states are applied (i.e., multi-TRP operation), only the channel/signals that are configured for multi-TRP operation may be transmitted/received by two network nodes 16 (e.g., TRPs). For example, let us assume that PDSCH and PUSCH are RRC configured with multi-TRP operation (e.g., by setting multi-TRP related parameters in PDSCH-Config IE and PUSCH-Config IE such as specified in 3GPP TS 38.311), but PUCCH is not RRC configured for multi-TRP operation. In this nonlimiting example, when two DL TCI states are applied, only the channels/signals that is configured for multi-TRP operation may apply the multi-TRP transmission/reception (i.e. PDSCH and PUSCH in this case). For PUCCH, since it has not been configured for multi-TRP operation, single-TRP operation may be performed for PUCCH. Which one of the two applied DL TCI states (either the first one or the second one) the WD 22 should use when determining the TX spatial filter for the PUCCH may be pre-determined based on a specification and/or dynamically indicated with a field in a DCI used to trigger the PUCCH.

In one other example of this embodiment, for separate DL/UL TCI indication, TCI field codepoints may be associated with one or two activated DL TCI states and one or two activated UL TCI states, such as schematically illustrated in FIG. 26. In cases the WD 22 is indicated with a TCI state codepoint associated with a single activated DL TCI state, the WD 22 may use the single activated DL TCI state to determine a single RX spatial filter (i.e. single-TRP operation in DL). In cases where the WD 22 is indicated with a TCI field codepoint associated with two activated DL TCI states, the WD 22 may use the two activated DL TCI states to determine two RX spatial filter (i.e. multi-TRP operation in DL). In case the WD 22 is indicated with a TCI state codepoint associated with a single activated UL TCI state, the WD 22 will use the single activated UL TCI state to determine a single TX spatial filter (i.e., single-TRP operation in UL). In cases where the WD 22 is indicated with a TCI field codepoint associated with two activated UL TCI states, the WD 22 may use the two activated UL TCI states to determine two RX spatial filter (i.e., multi-TRP operation in DL).

In other words, depending on the indicated TCI field codepoint, dynamic switching between single-TRP and multi-TRP may be achieved for DL and UL independently. For example, in case a DCI with TCI field codepoint 2 is indicated to the WD 22, the WD 22 may update: (A) one RX spatial filter based on DL TCI state 9 for DL signals/channels (e.g. from a first TRP); (B) one TX spatial filter based on UL TCI state 1 for UL signals/channels (e.g. from a first TRP); and/or (C) one RX spatial filter based on DL TCI state 49 for DL signals/channels (e.g. from a second TRP). Put differently, multi-TRP operation may be used in DL and single-TRP operation may be used in UL.

### Embodiment 2: Explicit Switching Between Single-TRP and Multi-TRP Operation

When using implicit switching of single-TRP and multi-TRP operation (e.g., as described in Embodiment 1), there may be a time interval between a TCI state or states are indicated in a DCI and a time that the indicated TCI state or states can be used or applied. The time interval may be predetermined. For example, the TCI state(s) (or beam(s)) application time) may be at least X ms and/or Y symbols after a last symbol. The last symbol may correspond to an acknowledgment sent to the network node 16 (e.g., gNB) about the reception of the TCI state(s) or beam(s) indication in the DCI. In some embodiments, the switching between single-TRP and multi-TRP operation may be performed without the time interval described above (e.g., before the time interval elapses, with a reduced time interval, etc.). For example, the switching may be performed at least in part by using an explicit indication in DCI. The explicit indication may be configured to indicate whether a scheduled physical channel (e.g., PDSCH, PUSCH and/or PUCCH) is to be transmitted/received with one or two TCI states (without actually changing the applied TCI state(s) for the “common beam(s)”, wherein the applied TCI states may refer to indicated TCI states or common beams in effect prior to or at the time of receiving the DCI).

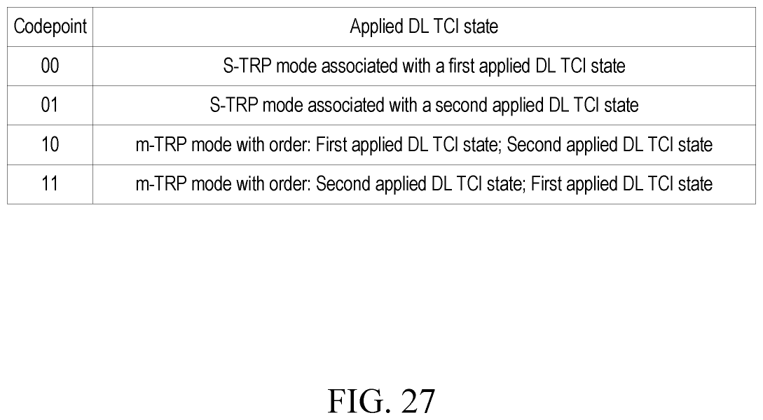

In one nonlimiting example of this embodiment, a bitfield may be used in a DL related DCI that triggers/schedules a PDSCH, where the bitfield is used to indicate whether single-TRP or multi-TRP reception is to be applied by the WD 22 for the triggered PDSCH only. The bitfield may include two bits (i.e., four codepoints). Assuming there are two applied TCI states in effect, then one codepoint may indicate single TRP operation associated with a first of the applied DL TCI states, and another codepoint may indicate single TRP operation associated with a second of the applied DL TCI states. One (or two) remaining codepoint(s) (e.g., the third and/or fourth codepoints) may indicate multi-TRP operation associated with both of the applied DL TCI states. Two codepoints (e.g., the third and fourth codepoints) may be used to indicate in which order the WD 22 may determine the RX spatial filter associated with the two applied DL TCI states such as in case TDM PDSCH repetition is applied. One example of how the mapping between the new bitfield codepoints and the single-TRP/multi-TRP operation is shown in FIG. 27.

In one embodiment, for codepoints having a predetermined value, e.g., ‘01’ and ‘11’, the order of the applied DL TCI states for multi-TRP PDSCH transmission may be used to indicate which applied DL/UL TCI state is to be transmitted. The applied DL/UL TCI state may be associated with PUCCH for a HARQ feedback. For example, in case a codepoint ‘10’ is indicated where the order is “First applied DL TCI state” and then “Second applied DL TCI state”, the WD 22 may transmit the PUCCH on a TX spatial filter determined based on the “First applied DL TCI state”.

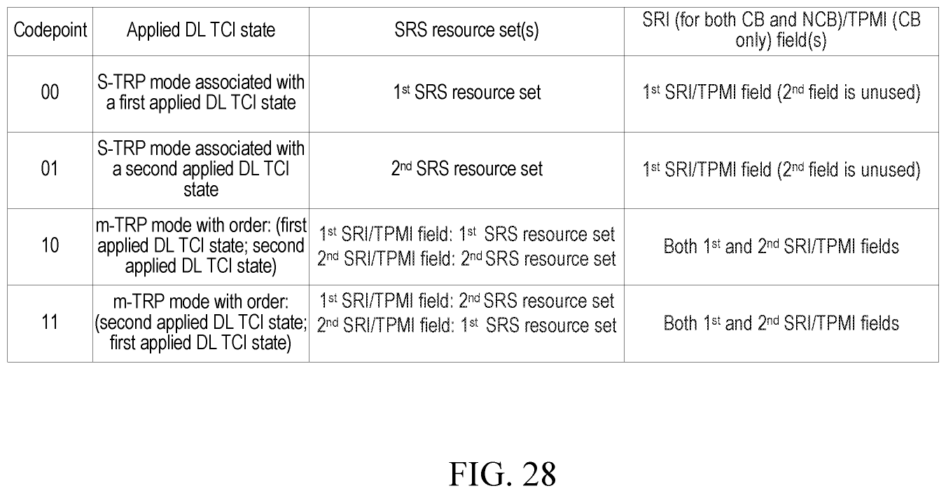

In another embodiment, a bitfield may be used in a UL related DCI that triggers a PUSCH. The bitfield may be used to indicate whether single-TRP or multi-TRP transmission is to be applied by the WD 22 for the triggered PUSCH. It may be assumed that the WD 22 has either two applied DL TCI states (for Joint DL/UL TCI) or two applied UL TCI states (for Separate DL/UL TCI) for the unified TCI state framework. In a nonlimiting example of this embodiment, the bitfield for PUSCH multi-TRP repetition may be used, as shown in FIG. 28. In this example, the “Applied DL TCI state” column indicates which one of the two applied UL TCI states (or DL TCI states in case of Joint DL/UL TCI) is to be used by the WD 22 to determine the TX spatial filter(s) for the single-TRP and multi-TRP transmission. One reason for differentiating in which order the WD 22 should use the two applied UL TCI state for multi-TRP transmission (i.e., for codepoint ‘10’ and ‘11’) may be to indicate to the WD 22 which applied UL TCI state the WD 22 should use to determine TX spatial filter for the first transmission of PUSCH during a TDM PUSCH repetition. Columns “SRS resource set(s)” and “SRI (for both CB and NCB)/TPMI (CB only) field(s)” may be used to associate a PUSCH transmission to SRS resource set(s) and SRI/TPMI bitfields in DCI. Although three columns and four rows are shown in FIG. 28, any other mapping (i.e., a table with more or fewer columns/rows) may be used.

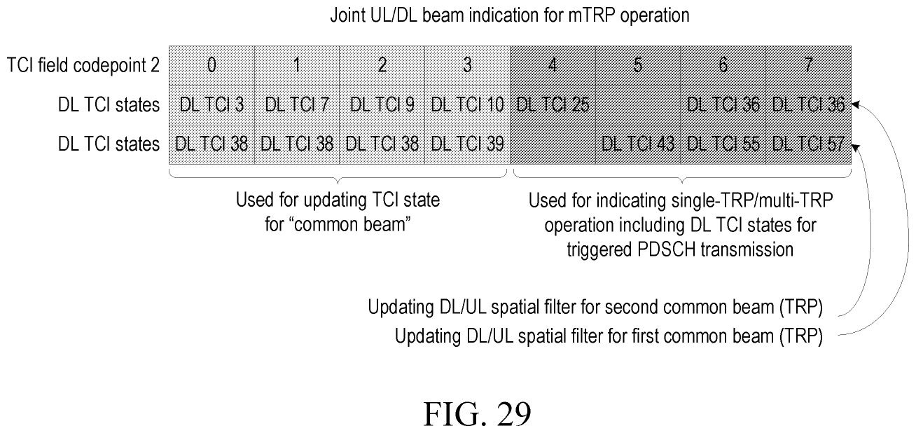

In one other example of this embodiment, one or more of the existing TCI field codepoints may be used for indicating single-TRP/multi-TRP operation for the triggered PDSCH (e.g., without updating the applied DL TCI state for the “Common beam”). FIG. 29 illustrates such other example, where the first 4 TCI field codepoints (e.g., 0-3) may be used to update the applied DL TCI states for the “common beams”. The last four TCI field codepoints (e.g., 4-7) may be used to indicate the Single-TRP/multi-TRP transmission of the triggered PDSCH (e.g., only for the PDSCH triggered with the same DCI containing the TCI field codepoint) including the associated activated DL TCI state(s) for the single-TRP or multi-TRP transmission. Indicating the TCI field codepoint for only the triggered PDSCH may be associated with lower latency compared to changing the applied TCI state for the “common beam”.

In one example of this embodiment, a scheme may be applied for the PUSCH, where a UL related DCI format may be used to indicate the TCI field codepoint (and/or where the TCI field codepoint indicates either one or two DL TCI states for Joint DL/UL TCI or one or two UL TCI states for Separate DL/UL TCI). Existing technology does not have TCI bitfield in UL related DCI formats. However, in this embodiment, a TCI bit field may be added to UL related DCI format.

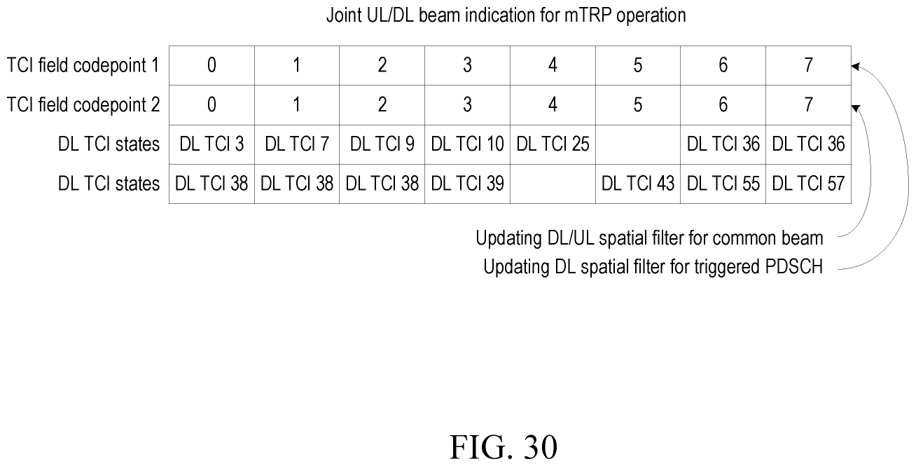

In one example of this embodiment, another TCI bitfield may be included in a DL related DCI format, where the TCI bitfield is used for indicating single-TRP/multi-TRP operation (including the associated activated DL TCI state(s)) for the triggered PDSCH (but without updating the applied DL TCI state for the “Common beam”). FIG. 30 illustrates such example, where a first TCI field codepoint (“TCI field Codepoint 1”) may be indicated in a first TCI bitfield and may be used to update the applied DL/UL TCI state for the “common beam”. A second TCI field codepoint (“TCI field Codepoint 2”) may be indicated in a second TCI bitfield and may be used to indicate the Single-TRP/multi-TRP transmission of the triggered PDSCH (i.e., PDSCH triggered with the same DCI as containing the TCI field codepoints) including the associated activated DL TCI state(s) for the single-TRP or multi-TRP transmission.

In one other example of this embodiment, a TCI field may be included in an UL related DCI format and may be used to indicate the Single-TRP/multi-TRP transmission of the triggered PUSCH (i.e. PUSCH triggered with the same DCI that comprises the TCI field codepoint) including the associated DL/UL TCI state(s) for the single-TRP or multi-TRP transmission. In an example of this embodiment, there may be two TCI fields in DL related DCI formats such as one for updating spatial filter for “common beam” and one for indicating the Single-TRP/multi-TRP transmission of the triggered PDSCH including the associated DL TCI state(s)) and one TCI field in UL TCI formats. The TCI field in the UL TCI formats may be used to indicate the Single-TRP/multi-TRP transmission of the triggered PUSCH including the associated DL/UL TCI state(s).

Although one or more embodiments are described using Joint DL/UL TCI, these embodiments are not limited as such, and any other TCI may be used such as Separate DL/UL TCI.

In some embodiments, a single TCI state associated with a single codepoint may be one of a pair of TCI states associated with another codepoint. A same/common beam may be used for both single TRP and multi-TRP operation. In another embodiment, when a TCI codepoint associated with a single TCI state is indicated to a WD 22, the TCI state (and/or another TCI state paired in another TCI codepoint) may be activated.

As an example, Table 1 shows TCI states activated by a MAC CE and their mapping to TCI codepoints, where each of TCI codepoints “0” and “1” is associated with two TCI states and each of codepoints 2 to 5 is associated with a single TCI state. When TCI codepoint “0” is indicated in a DCI, TCI states 2 and 4 are indicated. When codepoint “2” or “3” is indicated later in another DCI, there is no new TCI state change since TCI states 2 and 4 have already been indicated and are in effect. If any of codepoints “1”, “4”, and “5” is indicated later in another DCI, TCI states 3 and 5 would be selected as the new TCI states, and TCI states 2 and 4 are deactivated and are used. At any time, either a single TCI state or two (or more) TCI states may be indicated in a DCI for a single TRP or multi-TRP transmission, respectively. However, when a single TCI state is indicated in a DCI, it does not represent a change of TCI states. It may only indicate single TRP transmission for a PDSCH scheduled by the DCI. For other channels or signals, the two TCI states indicated prior to the DCI may be used, i.e. two TCI states may always be in effect unless single TRP transmission is indicated. The TCI states can be joint DL/UL TCI states or separate DL or UL TCI states.

TABLE 1
An example TCI states to TCI codepoints mapping.

| TCI | | | | | | |
|---|---|---|---|---|---|---|
| codepoint | 0 | 1 | 2 | 3 | 4 | 5 |
| 1^{st} TCI | TCI | TCI | TCI | TCI | TCI | TCI |
| state | state 2 | state 3 | state 2 | state 4 | state 3 | state 5 |
| 2^{nd} TCI | TCI | TCI | | | | |
| state | state 4 | state 5 | | | | |

As described in the present disclosure, the dynamic switching for UL may controlled by a field (e.g., a newly introduced field in UL related DCI), and the dynamic switching for DL may be controlled (e.g., separately) by another field (e.g., TCI field in DL related DCI). Some embodiments provide a common mechanism (e.g., using a TCI field present in a DL related DCI and/or using another TCI field present in a UL related DCI) for dynamic switching between single-TRP and multi-TRP operation for more than one of physical channel (e.g., PDSCH, PUSCH, and PUCCH). It should be noted that even though the TCI field present in DL and/or UL related DCI may be used for dynamic switching, the present embodiments are not limited as such and independent switching between single-TRP and multi-TRP may be used for the physical channels (e.g., PDSCH, PUSCH, and/or PUCCH). Independent switching may depend on the number (e.g., N) of DL/UL TCI states indicated by the codepoint in the TCI field of the DL and/or UL related DCI. For example:
Codepoint 1 may indicate 2 DL TCI states and 1 UL TCI state, i.e., multi-TRP reception for PDSCH using the 2 indicated DL TCI states, and PUSCH/PUCCH transmission towards single-TRP using the 1 indicated UL TCI state;
Codepoint 2 may indicate 2 DL TCI states and 2 UL TCI state, i.e., multi-TRP reception for PDSCH using the 2 indicated DL TCI states, and PUSCH/PUCCH transmission towards multi-TRP using the 2 indicated UL TCI states;
Codepoint 3 may indicate 1 DL TCI state and 2 UL TCI state, i.e., single-TRP reception for PDSCH using the 1 indicated DL TCI state, and PUSCH/PUCCH transmission towards multi-TRP using the 2 indicated UL TCI states;

If NN 16 (e.g., gNB) first indicates Codepoint 1 in the TCI field and next indicates Codepoint 2 in the TCI field, then multi-TRP reception may remain for PDSCH (using the 2 indicated DL TCI states in codepoints 1/2) but PUSCH/PUCCH transmission dynamically may switch from single-TRP (using 1 UL TCI state indicated in codepoint 1) to multi-TRP (using 2 UL TCI states indicated in codepoint 2).

If NN 16 (e.g., gNB) first indicates Codepoint 2 in the TCI field and next indicates Codepoint 3 in the TCI field, PUSCH/PUCCH transmission towards multi-TRP (using the 2 UL TCI states indicated in codepoints 2/3) may remain but PDSCH reception may switch from multi-TRP (using the 2 DL TCI states indicated in Codepoint 2) to single-TRP (using the 1 DL TCI state indicated in Codepoint 3).

The following is a nonlimiting list of example embodiments:

Embodiment A1. A network node configured to communicate with a wireless device (WD), the network node configured to, and/or comprising a radio interface and/or comprising processing circuitry configured to:
transmit a configuration comprising a list of TCI states;
activate a subset of the list of TCI states via MAC CE signaling to the WD, one or more of the TCI states being mapped to a single codepoint;
update a number, N, of the TCI states via DCI signaling to the WD; and
communicate with the WD using at least one of the TCI states based on the number N.

Embodiment A2. The network node of Embodiment A1, wherein the network node and/or the radio interface and/or the processing circuitry is configured to communicate with the WD using the at least one of the TCI states based on whether N is one of (i) equal to and (ii) greater than 1.

Embodiment A3. The network node of Embodiment A1, wherein the network node and/or the radio interface and/or the processing circuitry is configured to communicate with the WD using the at least one of the TCI states by being configured to:
if N=1 TCI state is updated, apply the indicated TCI state to a PDSCH and/or PUSCH/PUCCH; and
if N>=TCI states is updated, apply the indicated TCI states to the PDSCH and/or PUSCH/PUCCH.

Embodiment B1. A method implemented in a network node, the method comprising:
transmitting a configuration comprising a list of TCI states;
activating a subset of the list of TCI states via MAC CE signaling to the WD, one or more of the TCI states being mapped to a single codepoint;
updating a number, N, of the TCI states via DCI signaling to the WD; and
communicating with the WD using at least one of the TCI states based on the number N.

Embodiment B2. The method of Embodiment B1, wherein communicating with the WD using the at least one of the TCI states is based on whether N is one of (i) equal to and (ii) greater than 1.

Embodiment B3. The method of Embodiment B1, wherein communicating with the WD using the at least one of the TCI states comprises:
if N=1 TCI state is updated, applying the indicated TCI state to a PDSCH and/or PUSCH/PUCCH; and
if N>=TCI states is updated, applying the indicated TCI states to the PDSCH and/or PUSCH/PUCCH.

Embodiment C1. A wireless device (WD) configured to communicate with a network node, the WD configured to, and/or comprising a radio interface and/or processing circuitry configured to:
receive a configuration comprising a list of TCI states;
receive an activation of a subset of the list of TCI states via MAC CE signaling, one or more of the TCI states being mapped to a single codepoint;
receive DCI signaling updating a number, N, of the TCI states; and
communicate with the network node using at least one of the TCI states based on the number N.

Embodiment C2. The WD of Embodiment C1, wherein the WD and/or the radio interface and/or the processing circuitry is configured to communicate with the network node using the at least one of the TCI states based on whether N is one of (i) equal to and (ii) greater than 1.

Embodiment C3. The WD of Embodiment C1, wherein the WD and/or the radio interface and/or the processing circuitry is configured to communicate with the network node using the at least one of the TCI states by being configured to:
if N=1 TCI state is updated, apply the indicated TCI state to a PDSCH reception and/or PUSCH/PUCCH transmission; and
if N>=TCI states is updated, apply the indicated TCI states to the PDSCH reception and/or PUSCH/PUCCH transmission.

Embodiment D1. A method implemented in a wireless device (WD), the method comprising:
receiving a configuration comprising a list of TCI states;
receiving an activation of a subset of the list of TCI states via MAC CE signaling, one or more of the TCI states being mapped to a single codepoint;
receiving DCI signaling updating a number, N, of the TCI states; and
communicating with the network node using at least one of the TCI states based on the number N.

Embodiment D2. The method of Embodiment D1, wherein communicating with the network node using the at least one of the TCI states based on whether N is one of (i) equal to and (ii) greater than 1.

Embodiment D3. The method of Embodiment D1, wherein communicating with the network node using the at least one of the TCI states comprises:
if N=1 TCI state is updated, applying the indicated TCI state to a PDSCH reception and/or PUSCH/PUCCH transmission; and
if N>=TCI states is updated, applying the indicated TCI states to the PDSCH reception and/or PUSCH/PUCCH transmission.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the WD having been activated and indicated with first and second transmission configuration indicator, TCI, states for at least one of downlink, DL, reception and uplink, UL, transmission, by the WD, each of the first and the second unified TCI states comprising either a DL TCI state and a UL TCI state, or a joint UL and DL TCI state, the network node comprising:
processing circuitry configured to:
determine an indication indicating to the WD to perform one of the single-TRP operation and the multi-TRP operation for one or more physical channels, the determined indication including:
a first dedicated bit field in a downlink related downlink control information, DCI, scheduling a downlink physical channel; and
a second dedicated bit field in an uplink related DCI scheduling an uplink physical channel; and
a radio interface in communication with the processing circuitry, the radio interface being configured to:
transmit the determined indication to the WD.

2.-22. (canceled)

23. A method in a network node configured to communicate with a wireless device, WD, the WD having been activated and indicated with first and second transmission configuration indicator, TCI, states for at least one of downlink, DL, reception and uplink, UL, transmission by the WD, each of the first and the second unified TCI states comprising either a DL TCI state and a UL TCI state, or a joint UL and DL TCI state, the method comprising:
determining an indication indicating to the WD to perform one of the single-TRP operation and the multi-TRP operation for one or more physical channels, the determined indication including:
a first dedicated bit field in a downlink related downlink control information, DCI, scheduling a downlink physical channel; and
a second dedicated bit field in an uplink related DCI scheduling an uplink physical channel; and
transmitting the determined indication to the WD.

24.-44. (canceled)

45. A wireless device, WD, configured to communicate with a network node, the WD having been activated and indicated with first and second transmission configuration indicator, TCI, states for at least one of downlink, DL, reception and uplink, UL, transmission, by the WD, each of the first and the second TCI states comprising either a DL TCI state and a UL TCI state, or a joint UL and DL TCI state, the WD comprising:
a radio interface configured to:
receive an indication indicating to the WD to perform one of the single-TRP operation and the multi-TRP operation for one or more physical channels, the received indication including:
a first dedicated bit field in a downlink related downlink control information, DCI, scheduling a downlink physical channel; and
a second dedicated bit field in an uplink related DCI scheduling an uplink physical channel; and
processing circuitry in communication with the radio interface, the processing circuitry being configured to:
perform one of a single-transmission-reception operation and a multi-transmission-reception operation based on the received indication.

46.-66. (canceled)

67. A method in a wireless device, WD, configured to communicate with a network node, the WD having been activated and indicated with first and second transmission configuration indicator, TCI, states for at least one of downlink, DL, reception and uplink, UL, transmission by the WD, each of the first and the second TCI states comprising either a DL TCI state and a UL TCI state, or a joint UL and DL TCI state, the method comprising:
receiving an indication indicating to the WD to perform one of the single-TRP operation and the multi-TRP operation for one or more physical channels, the received indication including:
a first dedicated bit field in a downlink related downlink control information, DCI, scheduling a downlink physical channel; and
a second dedicated bit field in an uplink related DCI scheduling an uplink physical channel; and
performing one of a single-transmission-reception operation and a multi-transmission-reception operation based on the received indication.

68.-88. (canceled)
